(19) United States
(12) Patent Application Publication
(10) Pub. No.: US 2015/0058319 A1
(43) Pub. Date: Feb. 26, 2015

(54) ACTION SUPPORT APPARATUS, ACTION SUPPORT METHOD, PROGRAM, AND STORAGE MEDIUM

(71) Applicant: SONY CORPORATION, Tokyo (JP)

(72) Inventor: Yasushi MIYAJIMA, Kanagawa (JP)

(21) Appl. No.: 14/337,340

(22) Filed: Jul. 22, 2014

(30) Foreign Application Priority Data
Aug. 26, 2013 (JP) 2013-174603

(51) Int. Cl. G06F 17/30; G02B 27/01

(52) U.S. Cl. CPC G06F 17/30867; G02B 27/017
USPC 707/722; 707/769

(57) ABSTRACT

There is provided an action support apparatus including an acquisition unit configured to acquire information on a user, a support content deciding unit configured to decide support content for supporting a preference of the user determined on the basis of the information on the user acquired by the acquisition unit, and an execution unit configured to execute the support content in a process according to a level of the preference.

### CROSS REFERENCE TO RELATED APPLICATIONS

This application claims the benefit of Japanese Priority Patent Application JP 2013-174603 filed Aug. 26, 2013, the entire contents of which are incorporated herein by reference.

### BACKGROUND

The present disclosure relates to an action support apparatus, an action support method, a program, and a storage medium.

Agent-type audio interactive services are proposed today as apparatuses that support action of users. Mobile terminals such as smartphones and mobile phone terminals are also provided with a lot of applications that support the action in cooperation with positional information by showing recommended spots or restaurants from present locations. Users follow the shown routes to the destinations.

JP 2009-145234A discloses a guidance information showing system that can prevent unnecessary guidance information from being displayed or selected in a system that shows guidance information on restaurants or movie theaters at designated places. The selection of an item “go there” after the guide information is shown causes the guidance information showing system to search for a route from the present location to the shop and start the route guidance to the destination.

In addition to the route guidance as described above, an application is proposed that records the weight, calorie intakes, and amounts of exercise of users on a daily basis, and supports the users in weight loss on the basis of the recorded data (such as advising the users on weight loss and showing desired values).

### SUMMARY

Users, however, have to consider, determine, and set objectives bringing beneficial results to the users in the above-described action support application. This imposes a burden on users.

The above-described action support application explicitly keeps showing advice for supporting action of users, which makes the users feel stressed who have to suppress their desires while losing the weight or are reluctant to go on a diet, for example. It depends on will of users much whether advice or values shown for weight loss have some advantageous effects. Furthermore, imprecise or incorrect support content unfortunately makes users feel stressed.

Furthermore, although the above-described action support application explicitly shows advice for supporting action of users at any time, action support for preferences (such as hobbies and tastes) that users do not want other people to know may be undesirable depending on timing of the support. Preferences of users such as hobbies and tastes can be categorized into a plurality of levels indicating that the users allow the public to know the preferences, that the users want nobody to know the preferences, and that the users themselves have not recognized the preferences.

Accordingly the present disclosure proposes an action support apparatus, an action support method, a program, and a storage medium that can execute support content in a process according to a preference level, the support content matching with a preference of a user automatically determined on the basis of user information.

According to an embodiment of the present disclosure, there is provided an action support apparatus including an acquisition unit configured to acquire information on a user, a support content deciding unit configured to decide support content for supporting a preference of the user determined on the basis of the information on the user acquired by the acquisition unit, and an execution unit configured to execute the support content in a process according to a level of the preference.

According to another embodiment of the present disclosure, there is provided an action support method including acquiring information on a user, determining a preference of the user on the basis of the acquired information on the user, deciding support content for supporting the preference of the user, and executing the support content by a processor in a process according to a type of the preference.

According to still another embodiment of the present disclosure, there is provided a program for causing a computer to function as an acquisition unit configured to acquire information on a user, a support content deciding unit configured to determine a preference of the user on the basis of the information on the user acquired by the acquisition unit, and to decide support content for supporting the preference of the user, and an execution unit configured to execute the support content in a process according to a type of the preference.

According to yet another embodiment of the present disclosure, there is provided a non-transitory computer-readable storage medium having a program stored therein, the program causing a computer to function as an acquisition unit configured to acquire information on a user, a support content deciding unit configured to determine a preference of the user on the basis of the information on the user acquired by the acquisition unit, and to decide support content for supporting the preference of the user, and an execution unit configured to execute the support content in a process according to a type of the preference.

According to one or more of embodiments of the present disclosure, it becomes possible to execute support content in a process according to a preference level, the support content matching with a preference of a user automatically determined on the basis of user information.

The above-mentioned advantageous effects are not necessarily limited, but any other effects that are shown in the present specification or can be grasped from the present specification may also be attained in combination with or instead of the above-mentioned advantageous effects.

### BRIEF DESCRIPTION OF THE DRAWINGS

FIG. 1 is a diagram for describing an overview of an action support system according to an embodiment of the present disclosure;

FIG. 2 is a block diagram illustrating an example of a configuration of an HMD according to a first embodiment;

FIG. 3 is a diagram for describing preference levels according to the present embodiment;

FIG. 4 is a flowchart illustrating operational processing of determining the preference levels according to the present embodiment;

FIG. 5 is a flowchart illustrating processing of calculating a ‘preference degree’ according to the present embodiment;

FIG. 6 is a flowchart illustrating operational processing of determining a preference level of a user;

FIG. 7 is a flowchart illustrating processing of calculating a ‘preference degree’ based on a pupil size according to the present embodiment;

FIG. 8 is a diagram illustrating an example of a table in which the preference levels according to the present embodiment and an environment around a user are scored;

FIG. 9 is a flowchart illustrating action support processing according to the first embodiment;

FIG. 10 is a flowchart illustrating the action support processing according to the first embodiment;

FIG. 11 is a diagram illustrating an example of indirect action support offered by partially changing a captured image of a real space and displaying the changed captured image;

FIG. 12 is a diagram for describing indirect action support offered by partially changing a map image and displaying the changed map image;

FIG. 13 is a diagram for describing an overall configuration of an action support system according to a second embodiment;

FIG. 14 is a block diagram illustrating an example of a configuration of an action support server according to the second embodiment;

FIG. 15 is a diagram for describing an example of indirect action support according to the second embodiment;

FIG. 16 is a flowchart illustrating action support processing according to the second embodiment;

FIG. 17 is a block diagram illustrating a configuration of an HMD according to a third embodiment;

FIG. 18 is a diagram for describing route support in the third embodiment;

FIG. 19 is a flowchart illustrating operational processing of an action support apparatus according to the third embodiment;

FIG. 20 is a diagram for describing an overall configuration of an action support system according to an applied example of the third embodiment;

FIG. 21 is a flowchart illustrating operational processing of the action support system according to the applied example of the third embodiment; and

FIG. 22 is a flowchart illustrating the operational processing of the action support system according to the applied example of the third embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order.

1. Overview of Action Support System according to Embodiment of Present Disclosure

### 2. First Embodiment

2-1. Configuration

2-2. Operational Processing

2-3. Indirect Action Support Process

### 3. Second Embodiment

### 4. Third Embodiment

### 5. Conclusion

### 1. OVERVIEW OF ACTION SUPPORT SYSTEM ACCORDING TO EMBODIMENT OF PRESENT DISCLOSURE

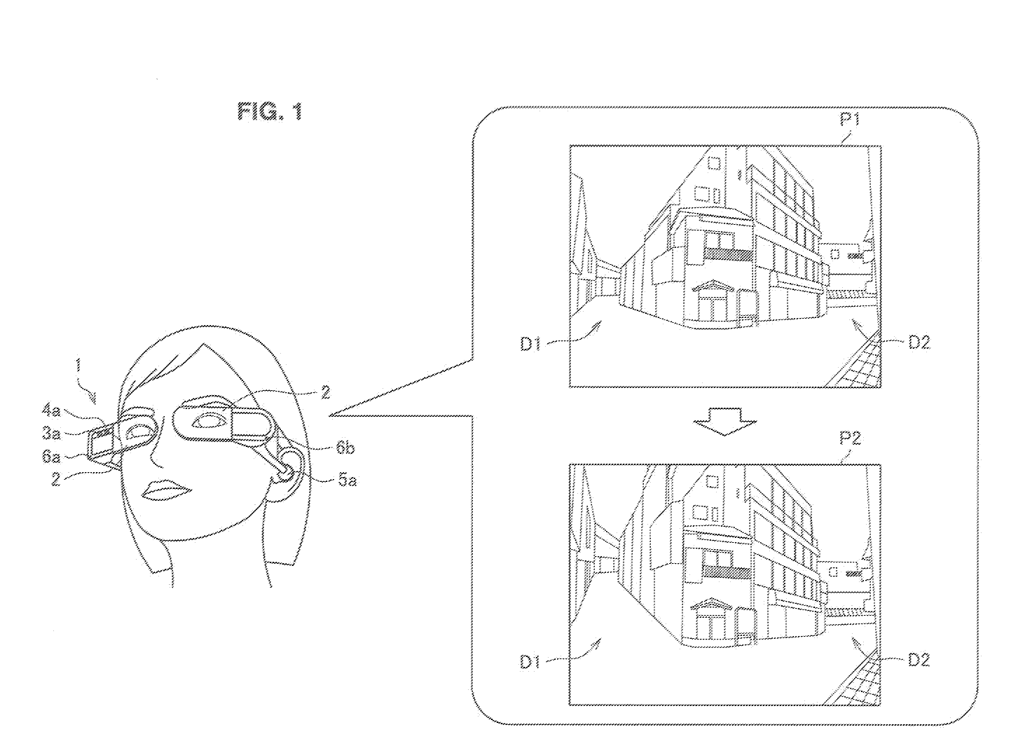

First of all, an overview of an action support system according to an embodiment of the present disclosure will be described with reference to FIG. 1. An action support apparatus used for implementing the action support system according to the present embodiment may be, for example, a head mounted display (HMD) 1 as illustrated in FIG. 1. The HMD 1 is like a pair of glasses as illustrated in FIG. 1, and includes a wearing unit having a frame structure that extends, for example, around half of a head from both sides to the back of the head. A user hangs the wearing unit at the auricles to wear the HMD 1. A pair of display units 2 for the left and right eyes is configured to be positioned in front of both eyes of the user while the HMD 1 is worn by a user. This means that the pair of display units 2 is disposed at a position of the lenses of general glasses. The display units 2 display, for example, a captured image obtained by an imaging lens 3a imaging a real space. The display units 2 may be transmissive. The HMD 1 brings the display units 2 into a through-state, which means that the display units 2 are transparent or semitransparent. Accordingly, even if a user wears the HMD 1 at all times like general glasses, the HMD 1 does not interfere with the daily life.

The imaging lens 3a is disposed toward the front so as to image an area in a direction visually recognized by a user as a subject direction while worn by the user as illustrated in FIG. 1. A light emitting unit 4a is installed to illuminate an area in an imaging direction of the imaging lens 3a. The light emitting unit 4a is formed of, for example, a light emitting diode (LED).

A pair of earphone speakers 5a is installed that can be inserted into both right and left ear holes of a user while the pair of earphone speakers 5a is worn by the user, although FIG. 1 illustrates only a single earphone speaker 5a for the left ear. Microphones 6a and 6b that collect external sounds are disposed on the right side of the display unit 2 for the right eye and the left side of the display unit 2 for the left eye.

FIG. 1 illustrates an example of an exterior of the HMD 1, but various structures that allow a user to wear the HMD 1 are also possible. The HMD 1 may be usually formed of a wearing unit like a pair of glasses or a wearing unit mounted on a head as long as the HMD 1 has the display units 2 disposed at least near and in front of the eyes of a user. Although display units 2 are installed for both eyes in pairs, a single display unit 2 alone may also be installed for one of the eyes.

The imaging lens 3a and the light emitting unit 4a, which illuminates an area, are disposed toward the front on the right eye side in the example of FIG. 1, but may also be disposed on the left eye side or both sides. Although the earphone speakers 5a are installed as stereo speakers for both ears, a single earphone speaker 5a alone may also be installed for one of the ears. One of the microphones 6a and 6b alone may also be installed. It is also possible that the microphones 6a and 6b, the earphone speakers 5a, or the light emitting unit 4a is not installed.

The HMD 1 can guide a user to a destination (example of action support) by displaying an image on the display units 2 or reproducing sounds from the earphone speakers 5a for guiding a user to a destination.

### BACKGROUND

As discussed above, the action support applications in the past request a user to consider, determine and set an objective that brings a beneficial result to the user, which imposes a burden on the user. The above-mentioned action support application keeps explicitly showing advice for supporting action of a user, which sometimes makes the user feel stressed.

A user has to determine whether shown advice is beneficial to the user, and has to consciously make a choice when some pieces of advice are shown.

Action support for a preference (such as a hobby and a taste) that a user does not want a person around the user to know may be undesirable for the user, depending on timing of the support. As discussed above, preferences of users such as hobbies and tastes can be categorized into a plurality of levels indicating that the users allow the public to know the preferences, that the users want nobody to know the preferences, and that the users themselves have not recognized the preferences.

In view of such circumstances, an action support apparatus is provided that can execute support content in a process according to a preference level, the support content matching with a preference of a user automatically determined on the basis of user information.

Specifically, the action support apparatus according to an embodiment of the present disclosure determines a preference of a user and decides action support content matching with the preference on the basis of content written by the user into a social networking service (SNS), a blog or electronic mail, and user information such as schedule information and biological information on the user. Accordingly, the user does not have to consider and set an objective, so that the user does not take any trouble or bear any burden.

The action support apparatus according to an embodiment of the present disclosure does not explicitly show advice for supporting action of a user, but supports action of the user in an indirect (implicit) process by using affordance, illusion, psychological guidance, or the like so as to work on the subconscious mind of the user, thereby allowing the user to feel less stressed from the action support.

Human minds include a conscious mind and a subconscious mind (which are also referred to as unconscious mind). Both minds are described as an “iceberg floating in the ocean.” Specifically, the conscious mind is the tip of the iceberg that extends out of the ocean, while the subconscious mind is the other part of the iceberg under the ocean. The subconscious mind is overwhelmingly larger and accounts for approximately 90% of the whole mind. People are unable to bring the subconscious mind into awareness.

Action is usually supported in a direct (explicit) process that works on the conscious mind of a user, in which the user considers and determines an objective. Examples of the processes include displaying advice on a screen and audibly outputting advice. The present embodiment, however, is not limited to such direct processes. Some objectives for action support allow action to be supported in an indirect (implicit) process so as to work on the subconscious mind of a user. Accordingly, the action support system according to the present embodiment can offer such natural and less stressful support that a user unconsciously selects some action.

Specifically, the action support system according to the present embodiment partially changes the brightness of a view that a user is watching through the display units 2 or partially transforms the view to guide the user and make the user unconsciously select a predetermined street. As illustrated in FIG. 1, for example, the HMD 1 generates an image P2 by transforming a part of a captured image P1 of a real space in which a street forks in two directions such that the left street D1 in the captured image P1 looks like an uphill slope, and displays the image P2 on the display units 2 to make a user unconsciously select the right street D2. Since a user tends to unconsciously select a flat street (right street D2) rather than an uphill slope (left street D1) in this case, natural and less stressful support can be offered. In addition to a human tendency to flat streets rather than uphill slopes, the action support system according to the present embodiment can also offer support that uses other human tendencies to light streets rather than dark streets, and streets in which people can see all around.

Furthermore, since people tend to get away from disturbing sounds, the action support system according to the present embodiment controls not an image but a sound such that a noise can be heard from a given direction, thereby allowing for natural and less stressful support.

In this way, the action support system according to the present embodiment provides a sensory organ (sight, hearing, smell, taste, and touch) of a user with a stimulus that works on the subconscious (unconscious) mind of the user, thereby allowing for natural and less stressful support.

The overview of the action support system according to an embodiment of the present disclosure has been described so far. Next, the action support system will be specifically described with a plurality of embodiments of the present disclosure.

### 2. FIRST EMBODIMENT

### 2-1. Configuration

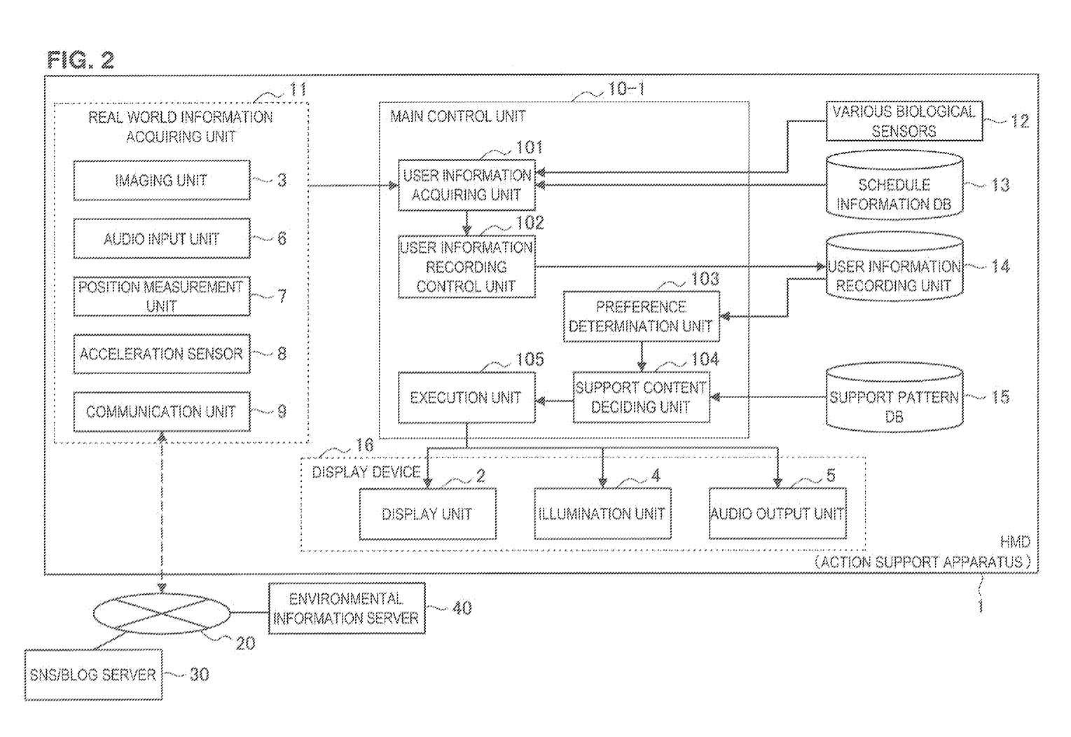

FIG. 2 is a block diagram illustrating an example of a configuration of an HMD 1 according to a first embodiment. The HMD 1 is an example of the action support apparatus. Examples of the action support apparatus according to the present embodiment may include a mobile apparatus (information processing apparatus) such as a smartphone, a mobile phone terminal, and a tablet terminal in addition to the HMD 1.

As illustrated in FIG. 2, the HMD 1 according to the present embodiment includes a main control unit 10-1, a real world information acquiring unit 11, various biological sensors 12, a schedule information DB 13, a user information recording unit 14, a support pattern database (DB) 15, and a showing device 16.

(Main Control Unit)

The main control unit 10-1 includes a microcomputer equipped with a central processing unit (CPU), read only memory (ROM), random access memory (RAM), a nonvolatile memory, and an interface unit, and controls each component of the HMD 1.

Specifically, as illustrated in FIG. 2, the main control unit 10-1 according to the present embodiment functions as a user information acquiring unit 101, a user information recording control unit 102, a preference determination unit 103, a support content deciding unit 104, and an execution unit 105.

The user information acquiring unit 101 acquires information on a user from the real world information acquiring unit 11, the various biological sensors 12, the schedule information DB 13, and the like. Specifically, the user information acquiring unit 101 acquires a present location, a moving speed and an amount of exercise of a user, content written by a user into an SNS/blog, an electronic bulletin board and electronic mail, audio input content, a history of online shopping in the Internet, and a Web browsing history from the real world information acquiring unit 11. The user information acquiring unit 101 acquires a heart rate and a sweat rate of a user (such as biological information and emotional information) from the various biological sensors 12. The user information acquiring unit 101 also acquires schedule information (action information) on a user from the schedule information DB 13.

The user information recording control unit 102 performs control such that the user information acquired by the user information acquiring unit 101 is recorded on the user information recording unit 14. The user information recording control unit 102 also records attribute information on a user such as sex and age on the user information recording unit 14. Attribute information on a user such as sex and age may be based on content input by the user in the form of an audio input, or may also be determined on the basis of information acquired from the various biological sensors 12 and the imaging unit 3.

The preference determination unit 103 determines a preference of the user on the basis of the user information recorded on the user information recording unit 14. The preference determination unit 103 determines a preference of the user, for example, on the basis of content written into an SNS/blog and a purchase history of online shopping. The preference determination unit 103 can further determine a preference in the subconscious mind of the user, which the user has not recognized, on the basis of a change in a pupil size calculated from a captured image obtained by the imaging unit 3 imaging an eye of the user or a heart rate and a sweat rate of the user acquired from the various biological sensors 12.

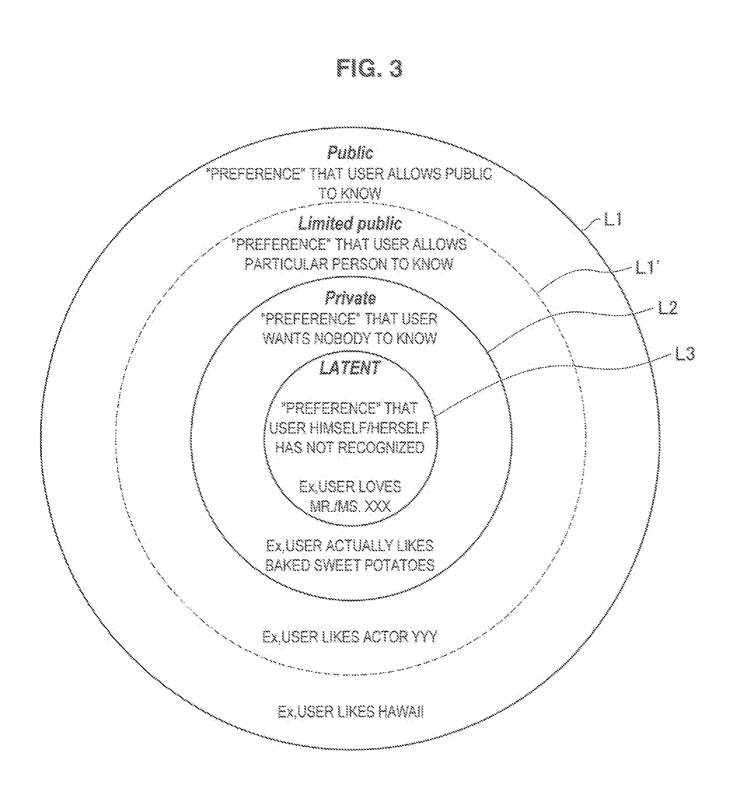

The preference determination unit 103 also sets a preference level of the user determined on the basis of the user information. Preference levels in the present embodiment will be described with reference to FIG. 3. FIG. 3 is a diagram for describing the preference levels according to the present embodiment. As illustrated in FIG. 3, human preferences include a preference that a person allows others to know (public level L1), a preference that a person wants nobody to know (private level L2), and a preference that a person himself/herself has not recognized in the subconscious mind (latent level L3). Additionally, the preference determination unit 103 can also set a preference that a person allows a particular range (group) of people to know (limited public level L1′) in the preference that a person allows others to know (public level L1) as illustrated in FIG. 3. The preference levels according to the present embodiment are categorized in this way on the basis of whether a user himself/herself has recognized a preference and whether a user allows others to know a preference.

If a positive expression is used, for example, for Hawaii in an SNS/blog open to the public, in which an individual user may be identified, the preference determination unit 103 determines that the user “likes Hawaii,” and sets the public level. Meanwhile, if nothing is written in an SNS/blog, in which an individual user may be identified, but a purchase history or a search history of “baked sweet potatoes” can be found in an online shopping history, a search history of the Internet, or a Web browsing history, the preference determination unit 103 determines that the user “actually likes baked sweet potatoes,” and sets the private level. Furthermore, if biological information indicates that a user gets tense with a particular person, the preference determination unit 103 determines that the user “loves the particular person,” and sets the latent level.

The support content deciding unit 104 decides support content for supporting a preference of a user determined by the preference determination unit 103. The support content deciding unit 104 may decide, for example, support content that displays information regarding an item or a service matching with a preference of a user, or support content that guides a user to a place in which an item or a service matching with a preference of the user is provided. Information regarding an item or a service matching with a preference of a user and information on a place in which the item or the service is provided may be collected through access to a variety of news sites, bulletin boards, SNSs, and Web sites in a network by using the preference of the user as a search keyword. The support content deciding unit 104 may then use the support pattern DB 15 to derive a word related to the preference of the user and use the word as a search keyword. When a preference of a user is, for example. “Hawaii,” the support content deciding unit 104 uses the support pattern DB 105 to derive related words “Waikiki.” “Hawaiian Jewelry.” and “Kilauea Volcano” associated with “Hawaii,” accesses a Web site using the derived related words as search keywords, and collects information related to “Hawaii.” which is the preference of the user.

The execution unit 105 uses the showing device 16 to execute the support content decided by the support content deciding unit 104. The execution unit 105 then executes the support content in a process according to a preference level that has been set by the preference determination unit 103. The process for executing support content includes a direct process in which support content is shown on the display units 2 or reproduced from an audio output unit 5, and an indirect process that works on the subconscious mind of a user to unconsciously do a predetermined act.

When a preference level is set indicating that a user himself/herself has recognized a preference and the user allows the public to know the preference (namely, the “public” level L1), the execution unit 105 directly executes support content in spite of whether there is anyone around the user or not.

When a preference level is set indicating that a user himself/herself has recognized a preference and the user allows a predetermined range of people to know the preference (namely, the “limited public” level L1′), and when a person around the user is included in the predetermined range of people (or there is no one around the user), the execution unit 105 directly executes support content. Additionally, it may be determined on the basis of facial recognition on a captured image from the imaging lens 3a or speaker recognition on a sound collected by the audio input unit 6 whether there is anyone included in the predetermined range of people around the user.

When a preference level is set indicating that a user himself/herself has recognized a preference and the user does not allow the public to know the preference (namely, the “private” level L2), and when there is no one (or no acquaintance) around the user (user is alone), the execution unit 105 directly executes support content. Additionally, it may be recognized on the basis of a captured image from the imaging lens 3a or an environmental sound/noise collected by the audio input unit 6 whether there is anyone (or acquaintance) around the user.

Furthermore, when a preference level is set indicating that a user himself/herself has not recognized a preference (namely, the “latent” level L3), the execution unit 105 works on the subconscious mind of the user and indirectly executes content support such that the user does not become conscious. Since a user has some latent tastes that the user does not want others to know, the execution unit 105 may be configured to indirectly execute support content only while there is no one (or acquaintance) around the user (user is alone), as in the “private” level L2.

The indirect process for executing support content with the display units 2 and the audio output unit 5 may use, for example, brightness change, color saturation change, aspect ratio change, rotation, echo/delay, and distortion/flanging. The following table 1 illustrates examples of image/audio processing and application examples of the image/audio processing. The application example of each image processing (such as brightness change and color saturation change) in the following Table 1 assumes that the action support apparatus according to the present embodiment, which is implemented as the HMD 1, processes at least a part of a captured image obtained by the imaging lens 3a imaging an area in a direction in which a user is looking and displays the processed captured image on the display units 2 to indirectly support action.

TABLE 1

| Content of Processing | Application Examples |
|---|---|
| Brightness Change | Light a direction in which a user is desired to be |
| | guided and darken a direction in which a user is desired |
| | to be kept away, so that the user is guided in the |
| | psychologically light direction |
| Color Saturation Change | Express an object desired to be prominent in a more |
| | vivid color, so that a user is unconsciously interested in |
| | the object |
| Aspect Ratio Change | Make a big person look slender or make a thin person |
| | look big |
| | Make a street look narrower than the real street to |
| | guide a user to the other street looking relatively wider |
| Rotation | Rotate a slanting signboard horizontal to make the |
| | letters easier to read |
| | Rotate a direction board having an arrow in the real |
| | world to point the arrow in a direction in which a user is |
| | desired to be guided |
| Enlargement/Reduction | Make food look bigger than the real food to simulate a |
| | satiety center so as to suppress the appetite of a user |
| Transformation | Makes a flat street look like a slope with trapezoidal |
| | transformation, so that a user unconsciously selects the |
| | other street, which is not a slope |
| | Transform, with trapezoid distortion correction, a |
| | signboard at which a user is diagonally looking into a |
| | quadrangle easy to read |
| Composition of Images | Superimpose an image of an object that does not |
| | actually exist |
| | Display a door that is not desired to be opened in the |
| | same color as the wall around the door, so that it looks |
| | as if the door did not exist |
| Mosaic/Blurring | Mosaic/blur a signboard desired to be hidden from a |
| | user, so that the signboard is invisible |
| Color Change | Make food look bad/good |
| | Make a face red like a drunk |
| Echo/Delay | Create the illusion of a narrower/wider space than the |
| | real space |
| Distortion/Flanging | Make an unusual sound to naturally direct attention of |
| | a user to the sound |
| | Make a noise with much distortion, so that a user feel |
| | uncomfortable and moves to another place |
| Surround Sound | Change a position of a sound source to guide a user in |
| Creation/Channel Change | a direction of the sound (e.g. when a user hears |
| | rollicking voices from the right front, the user would |
| | naturally feel like going to the right front) |

It has been described so far that when the execution unit 105 executes support content, the preference levels L1, L1′, L2, and L3 set by the preference determination unit 103 decide whether an environment around a user (whether there is anyone) is taken into consideration and which process (direct/indirect) for executing support content is used. Even though support content is executed while a user is concentrating on another thing, fewer advantageous effects would be attained. Accordingly, the execution unit 105 is also configured to show support content while a user is not concentrating on another thing, allowing more advantageous effects to be attained.

(Real World Information Acquiring Unit)

The real world information acquiring unit 11 acquires information on the real world (outside world) such as a situation around a user, environmental information, and information stored in a predetermined server in a network. Specifically, as illustrated in FIG. 2, the real world information acquiring unit 11 includes an imaging unit 3, an audio input unit 6, a position measurement unit 7, an acceleration sensor 8, and a communication unit 9.

The imaging unit 3 includes a lens system including an imaging lens 3a as illustrated in FIG. 1, a diaphragm, a zoom lens and a focus lens, a driving system for causing the lens system to focus and zoom, and a solid-state image sensor array for generating an imaging signal from photoelectric conversion of imaging light obtained in the lens system. The solid-state image sensor array may include a charge coupled device (CCD) sensor array and a complementary metal oxide semiconductor (CMOS) sensor array. The imaging lens 3a is disposed toward the front so as to image an area in a direction in which a user is looking as illustrated in FIG. 1, when the HMD 1 is worn by the user.

The audio input unit 6 includes microphones 6a and 6b as illustrated in FIG. 1, a microphone/amplifier unit for amplifying audio signals obtained from the microphones 6a and 6b, an A/D converter, and an audio signal processing unit. The audio input unit 6 performs noise reduction and sound source separation on the collected audio data with the audio signal processing unit. The audio input unit 6 then supplies the processed audio data to the main control unit 10-1. The HMD 1 according to the present embodiment includes the audio input unit 6 to allow a user to input a sound, for example.

The position measurement unit 7 has a function of acquiring information on a present location of the HMD 1 on the basis of an externally acquired signal. The position measurement unit 7 includes, for example, a global positioning system (GPS) positioning unit. The GPS positioning unit receives radio waves from a GPS satellite to position a location of the HMD 1 (present location). In addition to the GPS positioning unit, the position measurement unit 7 can also acquire information on a present location through transmission and reception in Wi-Fi (registered trademark), and transmission and reception with another mobile phone, PHS and smartphone, or through near filed communication to measure the present location.

The acceleration sensor 8 is an example of motion sensors that detect movement of the HMD 1. The HMD 1 may further include a gyro sensor in addition to the acceleration sensor 8. Detection results from the acceleration sensor 8 and the gyro sensor allow for determination of how a user is moving, on foot, by bicycle or by car, and an amount of exercise of the user may also be detected.

The communication unit 9 transmits data to and receives data from an external apparatus. The communication unit 9 communicates with an external apparatus directly or via a network 20 in a scheme such as a wireless local area network (LAN), Wireless Fidelity (Wi-Fi) (registered trademark), infrared communication, and Bluetooth (registered trademark). Specifically, as illustrated in FIG. 2, the communication unit 9 communicates with an SNS/blog server 30 and an environmental information server 40 via the network 20. Additionally, the environmental information server 40 stores information on weather, temperature, humidity, precipitation, wind directions, and force of wind in each area as environmental information.

(Various Biological Sensors)

Various biological sensors 12 detect biological information on a user, in particular, are implemented, for example, as a brain wave sensor, a heart rate (pulse) sensor, a perspiration sensor, a body temperature sensor, and a myoelectric sensor. The imaging unit 3 can also be used as an example of biological sensors. Specifically, if the imaging lens is inwardly disposed so as to image an eye of a user when the HMD 1 is worn by the user, a pupil size (example of biological information) and the eye movement can be detected on the basis of a captured image obtained from the imaging lens. The various sensors 12 may be mounted on the HMD 1, or be directly worn by a user separately from the HMD 1. In the latter case, the various biological sensors 12 transmit the detected biological information to the HMD 1.

The following Table 2 illustrates an example of information acquired on the basis of indices detected by the various biological sensors 12.

TABLE 2

| Indices to be | |
|---|---|
| Detected | Information to be Acquired |
| Heart Rate, Pulse | tension level, exercise intensity, vascular age |
| Pupil | level of interest in what a user is looking at |
| Perspiration | tension level, exercise intensity, heat and discomfort |
| (Electrical Skin | felt by the body |
| Resistance) | |
| Brain Waves | emotions such as joy, anger, pathos, and humor, |
| | concentration/relaxation level |
| Myoelectricity | motion, body movement, fidgeting |
| Eye Movement | sleep state, drowsiness detection, concentration level, |
| | calmness level |
| Blood Glucose | hunger level |
| Level | |
| Body | detection of physical condition (compared with daily |
| Temperature | changes), detection of unusualness |

(Schedule Information DB)

The schedule information DB 13 stores schedule information on a user which has been input in advance.

(User Information Recording Unit)

The user information recording unit 14 records the user information acquired by the user information acquiring unit 101 under the control of the user information recording control unit 102.

(Support Pattern DB)

When the support content deciding unit 104 decides support content, the support pattern DB 15 stores a search keyword for collection of information on a preference of a user in association with the preference of the user. Keywords such as “Waikiki,” “Hawaiian Jewelry,” and “Kilauea Volcano” are stored in association with a word “Hawaii.”

(Showing Device 16)

The showing device 16 directly/indirectly shows support content under the control of the execution unit 105. Specifically, as illustrated in FIG. 2, the showing device 16 includes display units 2, an illumination unit 4, and an audio output unit 5.

The display units 2 are implemented, for example, as liquid crystal displays, and disposed in pairs in front of both eyes of a user for the left and right eyes when the HMD 1 is worn by the user as illustrated in FIG. 1. This namely means that the display units are disposed at a position of the lenses of general glasses. The display units 2 are brought into a through-state or a non through-state, or display an image under the control of the execution unit 105.

The illumination unit 4 includes a light emitting unit 4a as illustrated in FIG. 1, and a light emitting circuit that causes the light emitting unit 4a to emit light. The light emitting unit 4a in the illumination unit 4 is attached so as to illuminate a front area as illustrated in FIG. 1, so that the illumination unit 4 illuminates an area in a direction in which a user is looking.

The audio output unit 5 includes a pair of earphone speakers 5a as illustrated in FIG. 1, and an amplifier circuit for the earphone speakers 5a. The audio output unit 5 may also be configured as a so-called bone conduction speaker. The audio output unit 5 outputs (reproduces) audio signal data under the control of the main control unit 10-1.

The configuration of the HMD 1 according to the present embodiment has been specifically described so far. Next, operational processing for action support according to the present embodiment will be described in detail.

### 2-2. Operational Processing

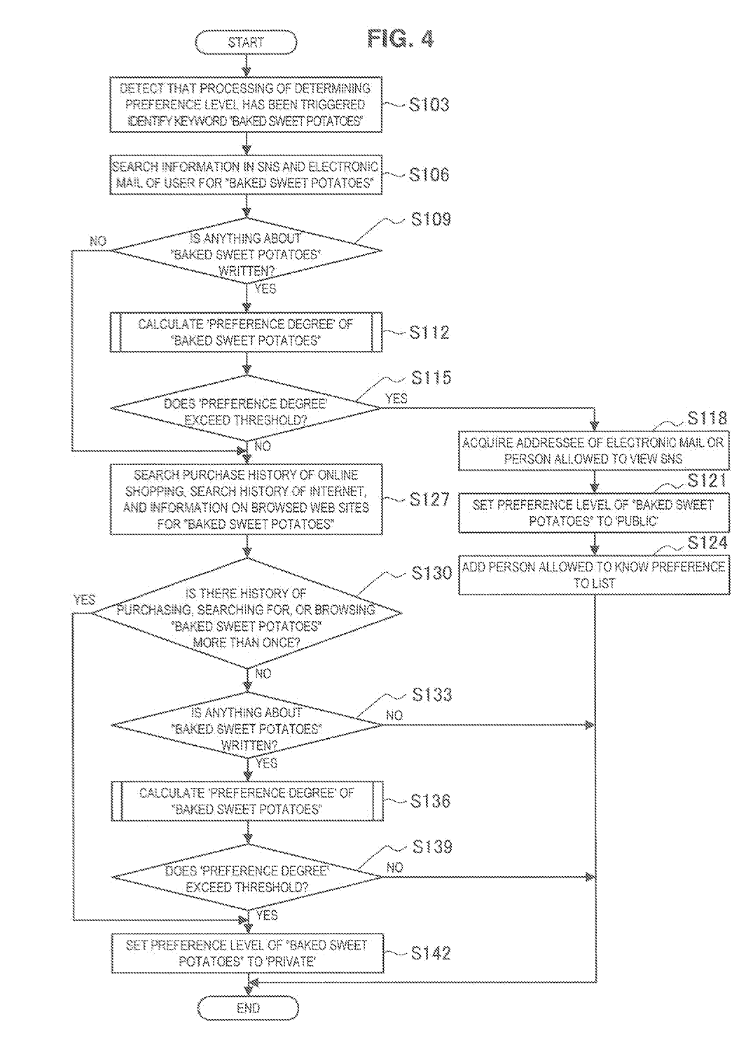

As discussed above, the HMD 1 according to the present embodiment determines a preference of a user and a preference level of the user, and offers action support matching with the preference of the user in a process according to the preference level. Here, processing of determining a preference level of a user will be specifically described with reference to FIGS. 4 to 7.

(2-2-1. Processing of Determining Preference Level)

FIG. 4 is a flowchart illustrating operational processing of determining “public” (level of a preference that a user allows others to know), and “private” (level of a preference that a user does not want others to know), which are both examples of preference levels of a user. The operational processing as illustrated in FIG. 4 may be regularly/irregularly performed, and the determined preference level may remain updated at all times.

As illustrated in FIG. 4, in step S103, the preference determination unit 103 included in the main control unit 10-1 of the HMD 1 first detects that processing of determining a preference level has been triggered, and identifies a search word. When a new keyword (that has not yet been subjected to preference determination) is regularly/irregularly extracted from user information recorded on the user information recording unit 14, the preference determination unit 103 recognizes that it is detected that the processing of determining a preference level has been triggered, and identifies the extracted keyword as a search word. Examples of the user information recorded on the user information recording unit 14 include schedule information, visual recognition target information on a user based on a captured image, audio input information including user speech, and information related to content written by the user into an SNS/blog and acquired via the communication unit 9 and transmitted content in electronic mail.

In step S106, the preference determination unit 103 then determines whether the information on an SNS, a blog, and electronic mail of the user includes something related to a search word “baked sweet potatoes.” SNSs, blogs, electronic mail, and the like have content open to a particular person or the public. Accordingly, if the user writes something about the search word “baked sweet potatoes” in this form, it is determined that the user allows others to know an idea of the user related to “baked sweet potatoes.”

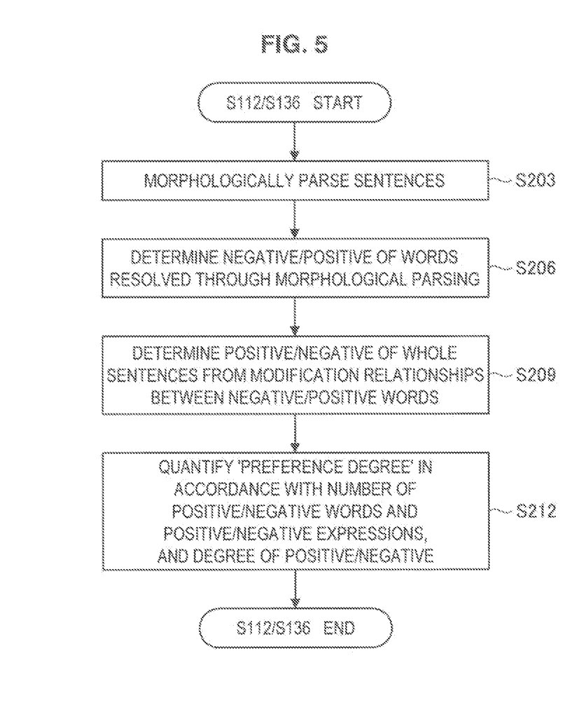

If something about the search word “baked sweet potatoes” has been written (S109/Yes), the preference determination unit 103 determines a ‘preference degree’ of “baked sweet potatoes” in step S112. Processing of calculating a ‘preference degree’ by the preference determination unit 103 will be discussed below with reference to FIG. 5.

Next, in step S115, the preference determination unit 103 determines whether the calculated ‘preference degree’ exceeds a threshold.

If the ‘preference degree’ exceeds the threshold (S115/Yes), the preference determination unit 103 then acquires, in step S118, information on a person who can view the SNS having something about the search word “baked sweet potatoes” written therein, or an addressee of the electronic mail having something about the search word “baked sweet potatoes” written therein.

Next, in step S121, the preference determination unit 103 sets a preference level of “baked sweet potatoes” to ‘public.’ As discussed above, SNSs and the like have content open to a particular person or the public. Accordingly, if the user has written positive content on the search word “baked sweet potatoes” into an SNS, it is determined that the user allows others to know that the user likes “baked sweet potatoes.”

Next, in step S124, the preference determination unit 103 adds the person acquired in step S118 to a list (which is also referred to as white list), the person being allowed to view the preference of the user.

To the contrary, if nothing about the search word “baked sweet potatoes” is written in an SNS in S109 (S109/No), or if the ‘preference degree’ calculated in S115 does not exceed the threshold (S115/No), the preference determination unit 103 searches a search history of the Internet and the like in step S127. Specifically, the preference determination unit 103 searches a purchase history of online shopping of the user, a search history of the Internet of the user, or information on a Web site that the user has browsed, which are recorded on the user information recording unit 14, for the search word “baked sweet potatoes” in step S127.

In step S130, the preference determination unit 103 then determines whether the user has purchased, searched for, or browsed “baked sweet potatoes,” which are the search word, more than once.

Next, if “baked sweet potatoes,” which are the search word, have not purchased more than once (S130/No), the preference determination unit 103 determines, in step S133, whether the purchase history, the search history of the Internet, the browsed Web site, or the private memorandum data shows that the user has written something about the search word “baked sweet potatoes.”

If something about “baked sweet potatoes” has been written (S130/Yes), the preference determination unit 103 then calculates a ‘preference degree’ of the search word “baked sweet potatoes” in step S136. Processing of calculating a ‘preference degree’ by the preference determination unit 103 will be discussed below with reference to FIG. 5.

Next, in step S139, the preference determination unit 103 determines whether the calculated ‘preference degree’ exceeds a threshold.

If the ‘preference degree’ exceeds the threshold (S139/Yes), and if “baked sweet potatoes” have been purchased more than once in S130 (S130/Yes), the preference determination unit 103 sets the preference level of “baked sweet potatoes” to ‘private’ in step S142. The online shopping history or the private memorandum data does not have content open to others. Accordingly, if a user has written positive content about the search word “baked sweet potatoes” in such a private manner, it is determined that the user does not want others to know that the user likes “baked sweet potatoes.”

The processing of determining public and private according to the present embodiment has been specifically described so far. Next, the calculation of a ‘preference degree’ by the preference determination unit 103 in S112 and S136 will be specifically described with reference to FIG. 5.

FIG. 5 is a flowchart illustrating processing of calculating a ‘preference degree’ according to the present embodiment. As illustrated in FIG. 5, in step S203, the preference determination unit 103 first morphologically parses sentences in which the search word “baked sweet potatoes” has been detected. Specifically, when calculating a ‘preference degree’ in S112, the preference determination unit 103 parses sentences in an SNS and a blog in which the search word “baked sweet potatoes” has been detected. When calculating a ‘preference degree’ in S136, the preference determination unit 103 parses sentences in a search history of the Internet and a private memorandum in which the search word “baked sweet potatoes” has been detected.

In step S206, the preference determination unit 103 then determines the negative/positive of each word on the basis of the meaning of each word that has been resolved through the morphological parsing.

In step S209, the preference determination unit 103 then determines the negative/positive of the whole sentences on the basis of modification relationships of the negative/positive words.

Next, in step S212, the preference determination unit 103 quantifies a ‘preference degree’ in accordance with the number of the negative/positive words, the number of the negative/positive expressions, the negative/positive of the whole sentences, or a degree of the negative/positive.

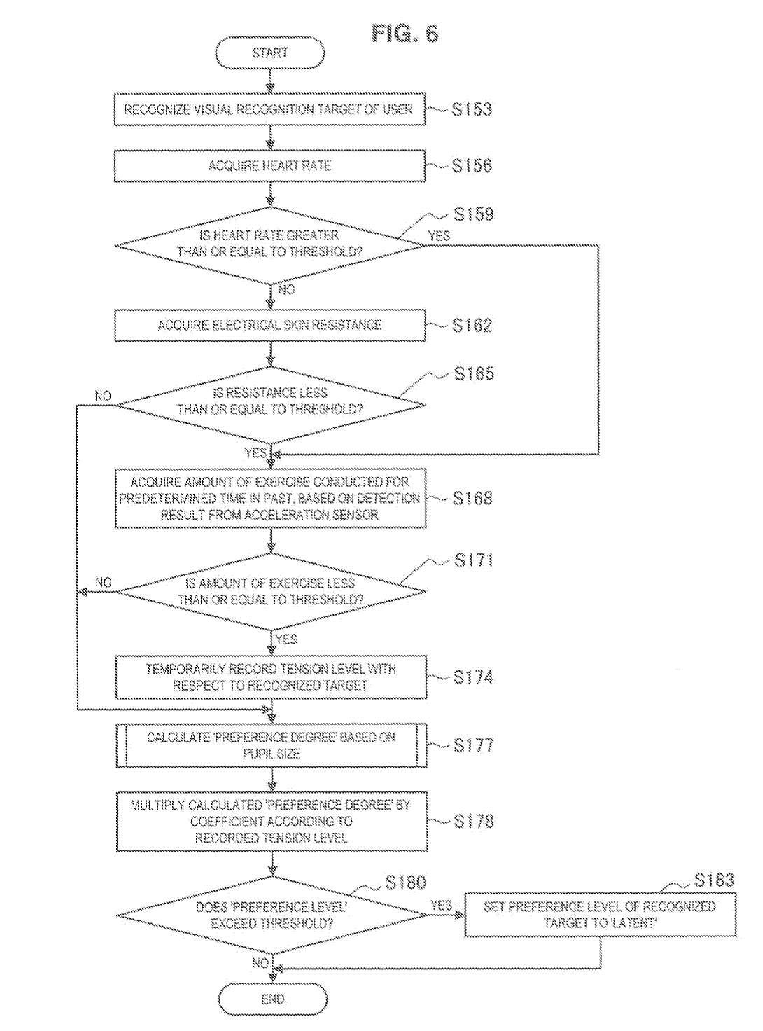

The calculation of a ‘preference degree’ by the preference determination unit 103 in S112 and S136 has been described so far in detail. Next, processing of determining another preference level by the preference determination unit 103 will be described with reference to FIG. 6.

FIG. 6 is a flowchart illustrating operational processing of determining “latent” (level of a preference that a user himself/herself has not recognized in the subconscious mind), which is an example of preference levels of a user. The processing as illustrated in FIG. 6 is performed on the basis of biological information acquired in real time. Although the present procedures use a heart rate, a sweat rate (electrical skin resistance), and a pupil size as an example of biological information, brain waves may also be additionally used.

As illustrated in FIG. 6, in step S153, the preference determination unit 103 first recognizes a visual recognition target of a user on the basis of a captured image obtained by the imaging lens 3a imaging an area in a direction in which the user is looking, the captured image being recorded on the user information recording unit 14. Additionally, when the HMD 1 has another imaging lens inwardly disposed so as to image an eye of a user, the preference determination unit 103 takes into consideration a direction in which the user is looking, which is based on an image of the eye of the user, achieving more accurate recognition of a visual recognition target of the user. If a visual recognition target is a person, the preference determination unit 103 performs facial recognition to identify the person.

Next, in step S156, the preference determination unit 103 acquires a heart rate of the user detected in real time by a heart rate sensor, which is an example of the various biological sensors 12, the heart rate being recorded on the user information recording unit 14.

In step S159, the preference determination unit 103 then determines whether the acquired heart rate exceeds a threshold.

Next, if the heart rate does not exceed the threshold (S159/No), the preference determination unit 103 acquires, in step S162, a sweat rate (electrical skin resistance value) of the user detected in real time by a perspiration sensor, which is an example of the various biological sensors 12, the sweat rate being recorded on the user information recording unit 14.

In step S165, the preference determination unit 103 then determines whether the acquired electrical skin resistance value is less than or equal to a threshold. A higher sweat rate reduces an electrical skin resistance value more. Thus, the determination of whether the electrical skin resistance value is less than or equal to the threshold allows it to be determined whether the sweat rate is more than or equal to a predetermined rate (rate in a normal state).

Next, if the electrical skin resistance value is less than or equal to the threshold (S165/Yes), or if the heart rate exceeds the threshold (S159/Yes), the preference determination unit 103 acquires, in step S168, an amount of exercise conducted for a predetermined time in the past (several minutes to several tens of minutes, for example) on the basis of a detection result from the acceleration sensor 8, the amount of exercise being recorded on the user information recording unit 14.

In step S171, the preference determination unit 103 then determines whether the acquired amount of exercise is less than or equal to a threshold. This is because data of the detected sweat rate or heart rate is not used for the calculation of the ‘preference degree’ in the present processing when the amount of exercise is large, for a larger amount of exercise usually causes more sweat and an increase in a heart rate.

Next, if the amount of exercise is less than or equal to the threshold (S171/Yes), the preference determination unit 103 (temporarily) records, in step S174, a tension level of the user with respect to the target (visual recognition target of the user) recognized in S153, in accordance with the heart rate and the sweat rate (electrical skin resistance).

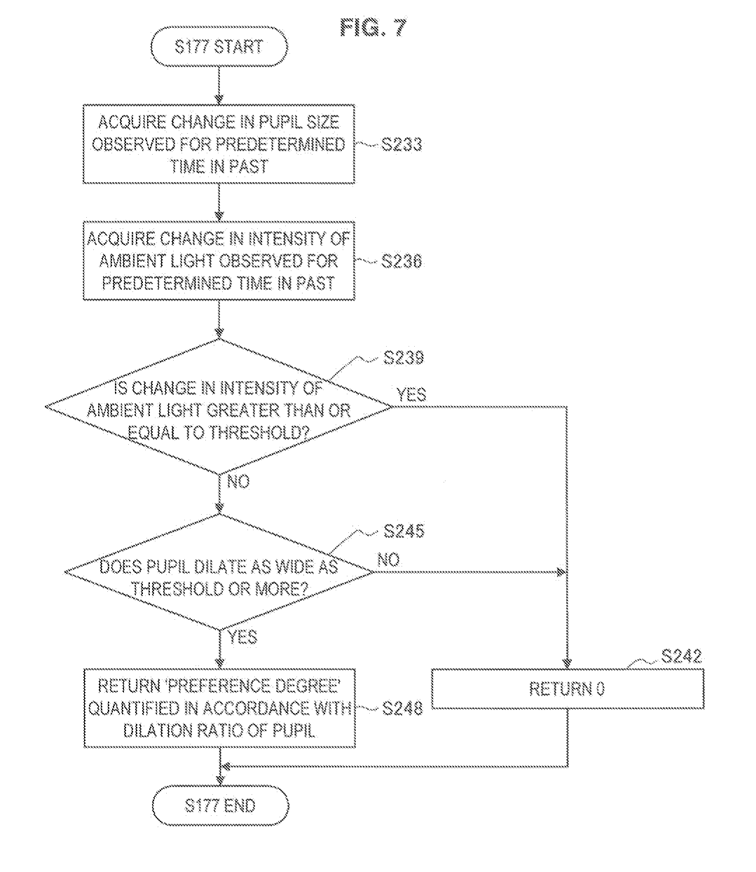

In step S177, the preference determination unit 103 then calculates the ‘preference degree’ on the basis of a pupil size of the user. The processing of calculating a ‘preference degree’ based on a pupil size of a user will be discussed below with reference to FIG. 7.

Next, in step S178, the preference determination unit 103 multiplies the calculated ‘preference degree’ by a coefficient according to the tension level recorded in S174. If no tension degree has been recorded because it was determined in S171 that the amount of exercise exceeds the threshold (S171/No), the preference determination unit 103 multiplies the calculated ‘preference degree’ by no coefficient.

In step S180, the preference determination unit 103 then determines whether the ‘preference degree’ exceeds a threshold.

If the threshold is exceeded, the preference determination unit 103 sets the preference level of the recognized target (visual recognition target of the user) to ‘latent’ in step S183. The ‘preference degree’ of the visual recognition target is calculated on the basis of biological information, which the user is unable to consciously control like the heart rate, the sweat rate, and the pupil size, and it is determined in the present processing whether the user likes/loves the visual recognition target. Thus, the preference determined in this way can be regarded as a preference in the latent level, which the user himself/herself has not recognized.

The processing of determining a preference in the latent level according to the present embodiment has been specifically described so far. Next, the calculation of a ‘preference degree’ based on a pupil size in S177 will be specifically described with reference to FIG. 7. A series of studies conducted by Hess et al. at the University of Chicago have revealed that the pupils of people dilate as people are looking at the other sex or a thing of interest. Thus, the preference determination unit 103 according to the present embodiment can estimate a target (thing/person) in which/whom a user unconsciously gets interested (likes/loves the target in the subconscious mind), on the basis of a change in a pupil size.

FIG. 7 is a flowchart illustrating processing of calculating a ‘preference degree’ based on a pupil size according to the present embodiment. As illustrated in FIG. 7, in step S233, the preference determination unit 103 first acquires a change in a pupil size of a user observed for a predetermined time in the past, the change being recorded on the user information recording unit 14. The change in a pupil size of the user is acquired on the basis of images of an eye of the user obtained by an imaging lens (not shown) in the HMD 1 continuously imaging the eye of the user, the imaging lens being inwardly disposed so as to image the eye of the user.

Next, in step S236, the preference determination unit 103 acquires a change in intensity of ambient light observed for a predetermined time in the past, the change being recorded on the user information recording unit 14. The change in intensity of ambient light may be continuously detected on the basis of an illumination sensor (not shown), which is an example of the real world information acquiring unit 11, or may also be acquired on the basis of continuous captured images from the imaging lens 3a.

In step S239, the preference determination unit 103 then determines whether the change in intensity of ambient light is greater than or equal to a threshold.

Next, if the change in intensity of ambient light is greater than or equal to the threshold (S239/Yes), the preference determination unit 103 returns “0” as a calculated value of a ‘preference degree’ in step S242. This is because it is not possible to regard a change in a pupil is caused by a change in ambient light as a change in a pupil caused in response to an emotion, for human pupils usually respond to an amount of light, so that the pupils dilate in the dark and contract in the light.

To the contrary, if the change in intensity of ambient light falls below the threshold (S239/No), the preference determination unit 103 determines, in step S245, whether or not the pupil has dilated as wide as threshold or more. That is, if the pupil size changes in spite of few changes in intensity of ambient light, it can be said that the pupil changes in response to an emotion. Since the pupils of people dilate as people are looking at the other sex or a thing of interest as discussed above, the preference determination unit 103 determines whether or not a pupil dilates as wide as the threshold or more, thereby determining whether a user likes/loves a visual recognition target.

If the pupil dilates as wide as the threshold or more (S245/Yes), the preference determination unit 103 returns, in step S248, a ‘preference degree’ quantified (calculated) in accordance with a dilation ratio of the pupil.

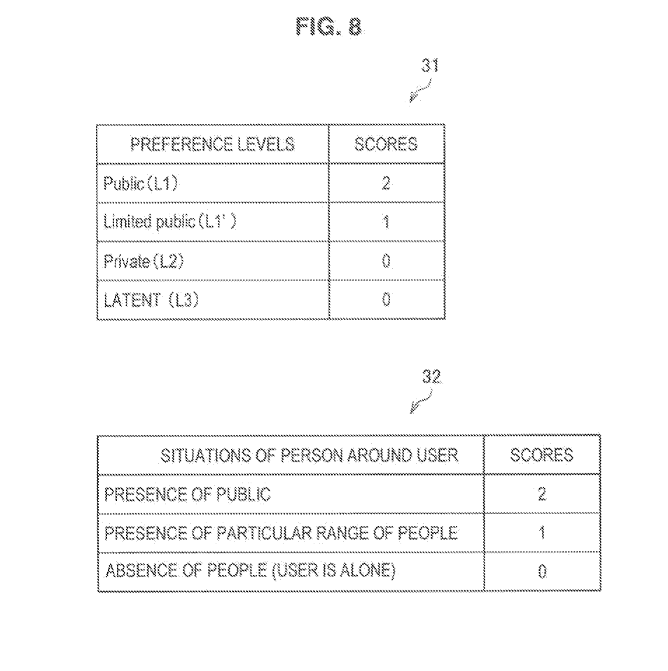

The determination of a preference and the setting of a preference level (public level, private level, and subconscious level) by the preference determination unit 103 according to the present embodiment have been specifically described so far with reference to FIGS. 4 to 7. Next, action support processing according to the present embodiment will be described with reference to FIGS. 8 to 10.

(2-2-2. Action Support Processing)

As an example, the action support processing according to the present embodiment scores a preference level and an environment of whether there is anyone around a user. FIG. 8 is a diagram illustrating an example of tables scoring preference levels and environments of whether there is anyone around a user. The upper score table in FIG. 8 is a level score (LS) table 31 scoring preference levels. For example, as illustrated in the LS table 31, let us assume that the score of the public level L1 is 2, the score of the limited public level L1′ is 1, and the scores of the private level L2 and the latent level L3 are 0.

The lower score table in FIG. 8 is an around one score (AOS) table 32 scoring a situation of a person around a user. For example, as illustrated in the AOS table 32, let us assume that the score for the presence of the public around a user is 2, the score for the presence of a predetermined range of people around a user is 1, and the score for the absence of people around a user, which namely means that the user is alone, is 0.

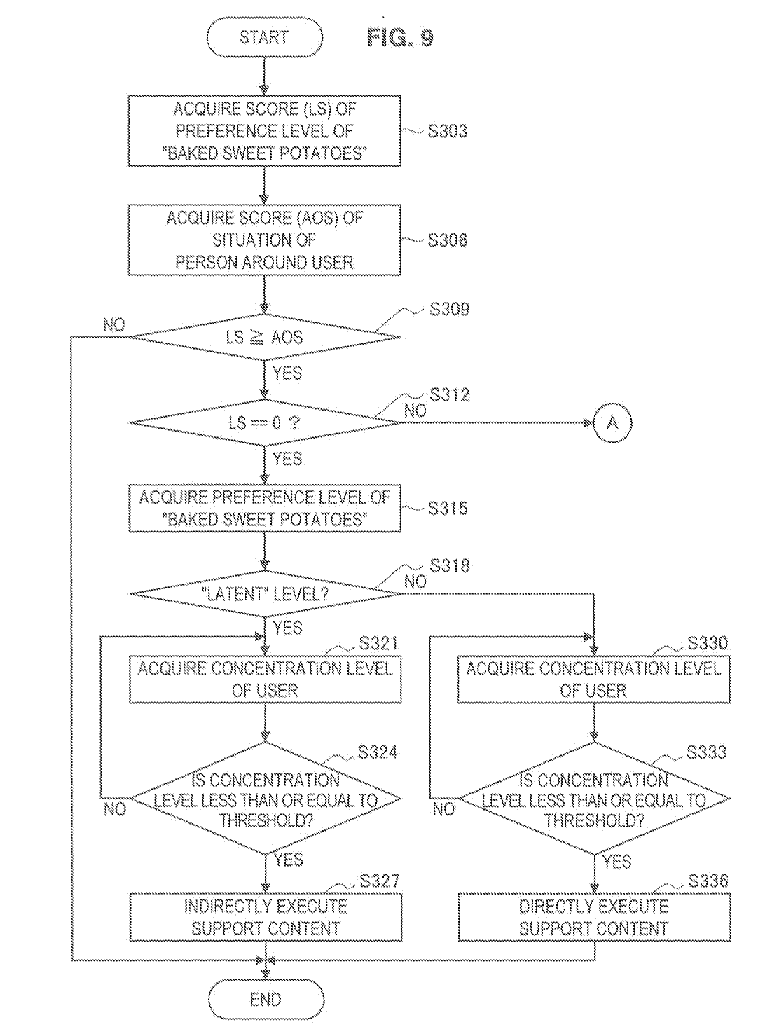

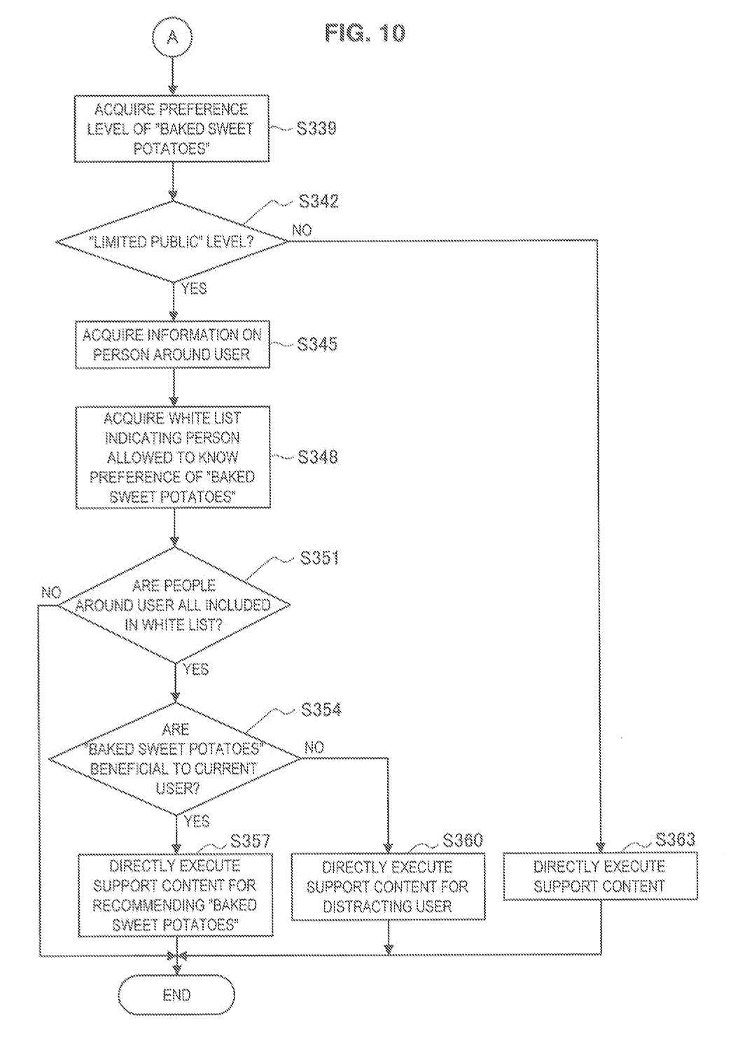

FIGS. 9 and 10 are flowcharts each illustrating action support processing according to the first embodiment. FIGS. 9 and 10 use “baked sweet potatoes” as an example of preferences of a user, and describe processing of offering action support for “baked sweet potatoes” (such as showing information on shops of “baked sweet potatoes” and guiding a user to the shops of “baked sweet potatoes”). As illustrated in FIG. 9, in step S303, the support content deciding unit 104 first acquires the score (LS) of a preference level of “baked sweet potatoes” set by the preference determination unit 103.

Next, in step S306, the execution unit 105 acquires the score (AOS) of a situation of a person around a user. The situation of a person around the user may be recognized on the basis of facial recognition on a captured image from the imaging lens 3a or speaker recognition on a sound collected by the audio input unit 6.

In step S309, the execution unit 105 then determines whether or not the score (LS) of the preference level is greater than or equal to the score (AOS) of the situation of a person around the user. If the LS is not greater than or equal to the AOS (S309/No), the action support according to the present embodiment is not offered. That is, when the preference level is the limited public level L1′ (LS=1), the private level L2 (LS=0), or the latent level (LS=0), and when there are people around the user (AOS=2), the action support according to the present embodiment is not offered. When the preference level is the private level or the latent level (LS=0), and when there are a predetermined range of people around the user (AOS=1), the action support according to the present embodiment is not also offered.

Next, in step S312, the execution unit 105 determines whether or not the score (AOS) of the situation of a person around the user is 0.

If the score (AOS) of the situation of a person around the user is 0, which namely means that there is no one around the user (user is alone) (S312/Yes), the execution unit 105 acquires, in step S315, the preference level of “baked sweet potatoes” set by the preference determination unit 103.

If the preference level of “baked sweet potatoes” is the latent level L3 (S318/Yes), the execution unit 105 then acquires a concentration level of the user in step S321. The concentration level of the user is acquired, for example, on the basis of brain waves or a direction in which the user is looking, which are detected by the various biological sensors 12.

If the concentration level of the user is less than or equal to a threshold (S324/Yes), the execution unit 105 indirectly executes, in step S327, the support content (such as guiding the user to the shops of “baked sweet potatoes”) decided by the support content deciding unit 104 so as to work on the subconscious mind of the user. “2-3. Indirect Action Support Process,” which will be discussed below, will specifically describe an indirect process for executing support content by the execution unit 105. The procedures as illustrated in FIG. 9 show that when the concentration level is less than or equal to the threshold, the support content is executed, so that the support content works on the subconscious mind more effectively. However, the action support processing according to the present embodiment is not limited to the procedures as illustrated in FIG. 9, but may execute support content, for example, without taking concentration levels into consideration.

To the contrary, if the preference level is not the latent level L3 in S318 (S318/No), and if the concentration level of the user is less than or equal to the threshold (S330, S333/Yes), the execution unit 105 directly executes the support content in step S336. When the preference level is not the latent level L3, the preference level shall be herein the private level L2, the limited public level L1′, or the public level L1.

Next, if the score (AOS) of the situation of a person around the user is not 0 in S312, which namely means that there is someone around the user (S312/No), the execution unit 105 acquires the preference level of “baked sweet potatoes” in step S339 as illustrated in FIG. 10.

If the preference level of “baked sweet potatoes” is the limited public level L1′ (S342/Yes), the execution unit 105 then acquires information on a person around the user (information indicating who is around the user) in step S345. The information on a person around the user may be recognized on the basis of facial recognition on a captured image from the imaging lens 3a or speaker recognition on a sound collected by the audio input unit 6.

Next, in step S348, the execution unit 105 acquires a white list indicating who is allowed to know the preference of “baked sweet potatoes.” The white list is created, in step S124 as illustrated in FIG. 4, by adding, to the list, a person who is allowed to know a preference.

In step S351, the execution unit 105 then determines whether people around the user are all included in the white list.

If people around the user are all included in the white list (S351/Yes), the execution unit 105 determines, in step S354, whether the action support for recommending “baked sweet potatoes” (such as showing information on shops of “baked sweet potatoes” and guiding the user to the shops of “baked sweet potatoes”) is beneficial to the current user. For example, if the user is physically challenged, if the action support financially damages the user, or if the user is on diet, it is determined that the action support for recommending “baked sweet potatoes” is disadvantageous to the user.

If it is determined that the action support is disadvantageous (S354/No), the execution unit 105 directly executes support content for distracting the user in step S360. The support content for distracting the user distracts the user's attention from the existence of “baked sweet potatoes.” Specifically, examples of the support content for distracting a user include guiding the user to a street that avoids a shop of “baked sweet potatoes.”

To the contrary, if it is determined that the action support is beneficial (S354/Yes), the execution unit 105 directly executes the support content for recommending “baked sweet potatoes” in step S357. The support content for recommending “baked sweet potatoes” brings the existence of “baked sweet potatoes” into the user's attention. Specifically, examples of the support content for recommending “baked sweet potatoes” include guiding the user to a street passing a shop of “baked sweet potatoes.”

Next, if it is determined, in step S342, that the preference level of “baked sweet potatoes” is not the limited public level L1′ (S342/No), the execution unit 105 directly executes the support content (for recommending “baked sweet potatoes”) in step S363. Additionally, when the preference level is not the limited public level L1′, the preference level shall be herein the public level L1.

### 2-3. Indirect Action Support Process

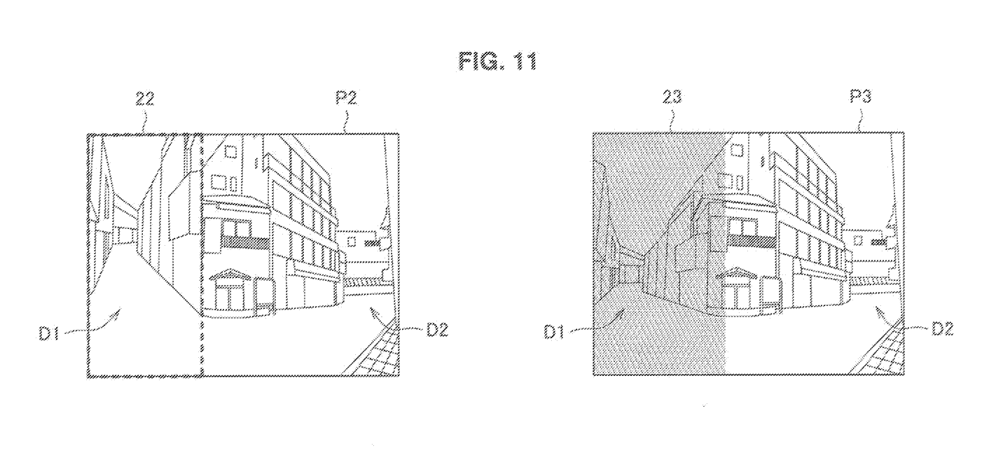

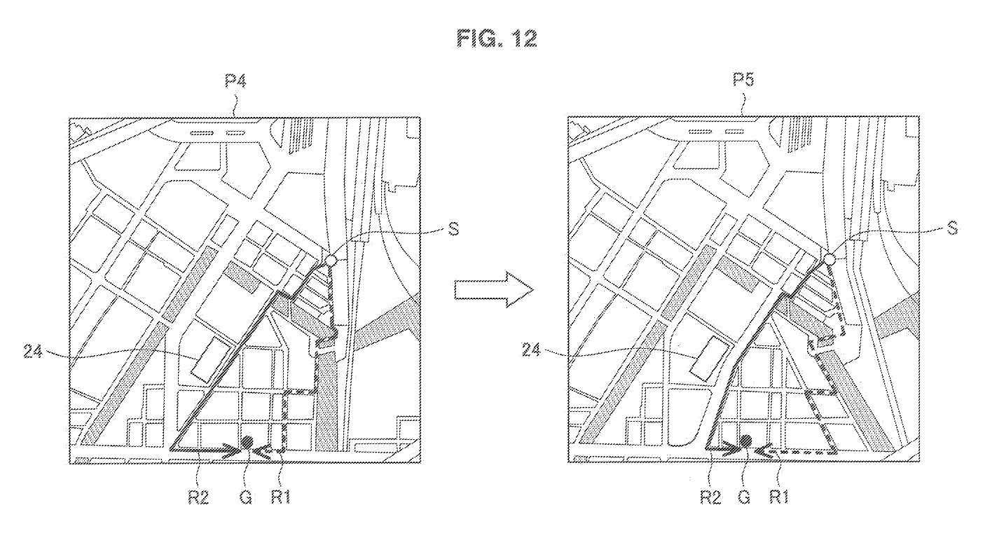

Next, an example of the indirect action support processes that work on the subconscious mind of a user will be described with reference to FIGS. 11 and 12.

FIG. 11 is a diagram illustrating an example of indirect action support offered by changing a part of a captured image of a real space. Here, when a street forks in two directions, the execution unit 105 offers action support for making a user unconsciously select the right street D2.

Specifically, as illustrated in the left of FIG. 11, the execution unit 105 generates an image P2 by transforming a part (area 22) of a captured image such that the left street D1 in the image looks like an uphill slope, and displays the image P2 on the display units 2. In this case, since a user tends to unconsciously select a flat street (right street D2) rather than an uphill slope (left street D1), the execution unit 105 can offer natural and less stressful support.

As illustrated in the right of FIG. 11, the execution unit 105 generates an image P3 by changing the brightness of a part (area 23) of the captured image such that the left street D1 in the captured image looks dark, and displays the image P3 on the display units 2. In this case, since a user tends to unconsciously select a light street (right street D2) rather than a dark street (left street D1), the execution unit 105 can offer natural and less stressful support.

FIG. 12 is a diagram for describing indirect action support offered by changing a part of a map image. A map image P4 illustrated in the left of FIG. 12 has not yet been subjected to image processing by the execution unit 105. When looking at the map image 4, a user usually selects a route R1, which is the shortest from the present location S to the destination G.

However, if the support content deciding unit 104 decides action support content for guiding a user to not a route R1 but a route R2 passing in front of a shop 24, which provides a thing that is determined as being unconsciously liked by the user, the execution unit 105 generates a map image P5 as illustrated in the right of FIG. 12.

Specifically, the execution unit 105 generates the map image P5 by distorting a part of the original map image P4 such that the route R2 looks the shortest from the present location S to the destination G and the route R1 looks longer than the route R2, and displays the map image P5 on the display units 2. The map image P5 as illustrated in the right of FIG. 12 is so transformed that a street of the route R2 grow thicker than other streets in width. In this case, it seems to a user that the route R2 had the shortest distance to the destination G compared with the route 1, which seems to have a longer distance to the destination G. In addition, a user tends to unconsciously select the route R2, which has a wide street like a main street. Accordingly, the execution unit 105 can offer natural and less stressful support.

### 3. SECOND EMBODIMENT

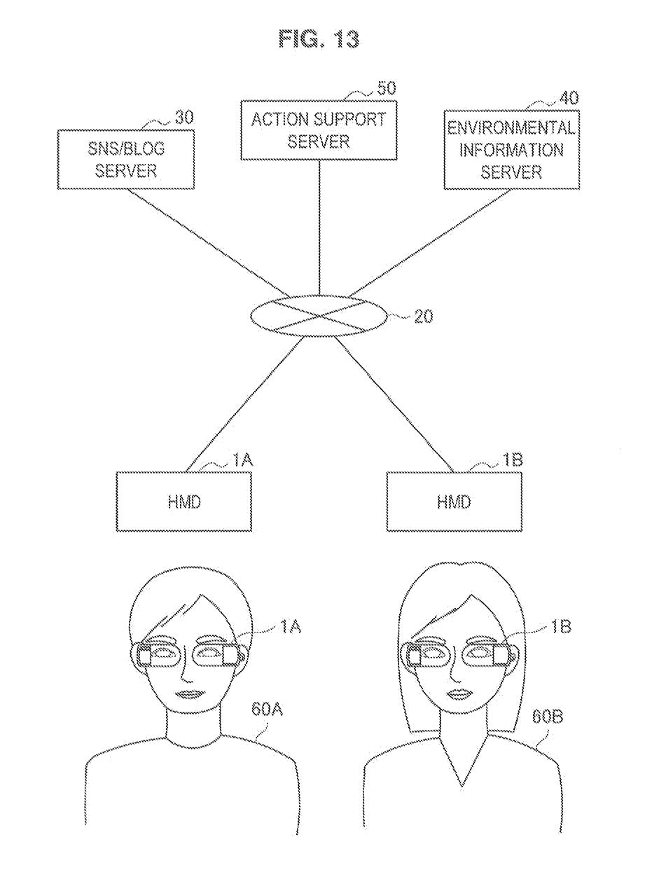

The above-described action support apparatus according to the first embodiment primarily offers action support for individuals. The action support apparatus according to an embodiment of the present disclosure, however, is not limited to action support for individuals. An action support system can be also implemented that offers the most suitable action support to separately acting people on the basis of their relationships. The specific description will be made below with reference to FIGS. 13 to 16.

### 3-1. Overall Configuration

FIG. 13 is a diagram for describing an overall configuration of an action support system according to a second embodiment. As illustrated in FIG. 13, the action support system includes a plurality of HMDs 1A and 1B, and an action support server 50 (example of the action support apparatus according to an embodiment of the present disclosure). The HMDs 1A and 1B are worn by different users 60A and 60B, respectively. The HMDs 1A and 1B wirelessly connect to the action support server 50 via a network 20, and transmit and receive data. Additionally, various servers such as an SNS/blog server 30 and an environmental information server 40 may be connected to the network 20.

The action support server 50 acquires information on the user 60A from the HMD 1A, and acquires information on the user 60B from the HMD 1B. The action support server 50 controls the HMDs 1A and 1B so that the HMDs 1A and 1B offer action support according to a relationship between the two users on the basis of the user information. For example, the HMDs 1A and 1B find a combination of an unmarried man and an unmarried woman whose preferences match with each other, and indirectly guide the couple to the same shop or the same place such that the couple naturally come across each other, thereby allowing for an increase in the possibility of their meeting.

The action support server 50 can also use content of electronic mail exchanged between the users 60A and 60B, content written by the users 60A and 60B into SNSs or blogs, or content written by a friend who knows the two users to determine whether the relationship between the two users is good or not. If the action support server 50 hereby determines, for example, that the two users have a quarrel (bad relationship), the action support server 50 uses the HMDs 1A and 1B to indirectly guide the two users to different streets, places, or shops such that the two users do not come across each other. To the contrary, if it is determined that the two users are on good terms (good relationship), the action support server 50 uses the HMDs 1A and 1B to indirectly guide the two users to the same street, place, or shop such that the two users come across each other.

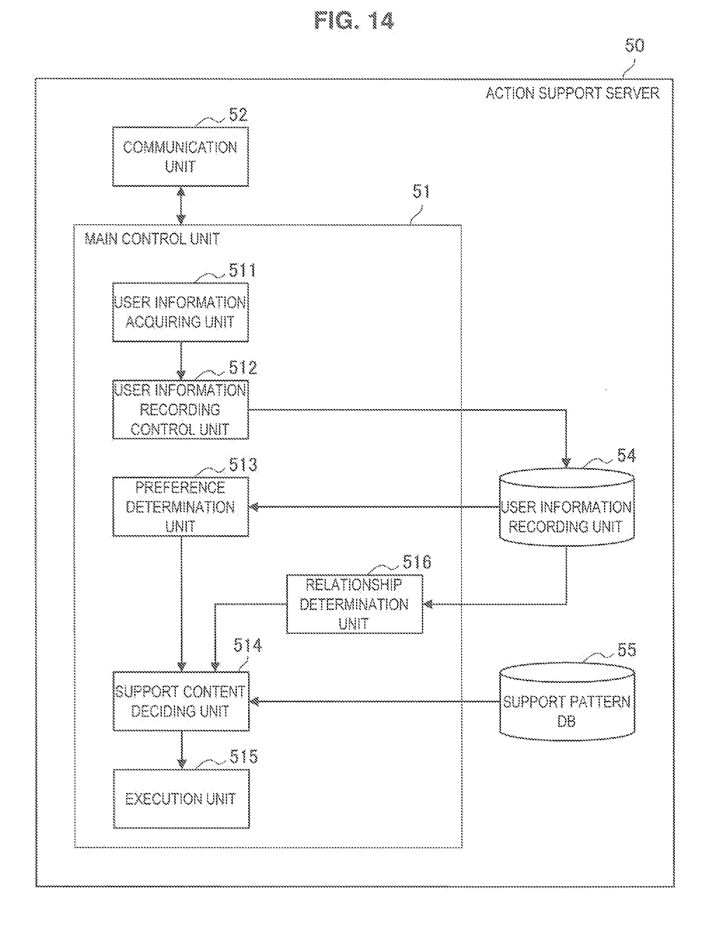

The overview of the action support system according to the second embodiment has been described so far. Next, a configuration of the action support server 50 included in the action support system according to the present embodiment will be described with reference to FIG. 14. The configurations of the HMDs 1A and 1B are the same as the configuration of the HMD 1 described in the first embodiment, so that the description will be herein omitted.

### 3-2. Configuration of Action Support Server 50

FIG. 14 is a block diagram illustrating an example of a configuration of an action support server 50 according to the second embodiment. As illustrated in FIG. 14, the action support server 50 (example of the action support apparatus) includes a main control unit 51, a communication unit 52, a user information recording unit 54, and a support pattern database (DB) 55. When offering action support according to a relationship between individual users, the action support server 50 may further include a relationship determination unit 516.

(Main Control Unit)

The main control unit 51 includes, for example, a microcomputer equipped with a central processing unit (CPU), read only memory (ROM), random access memory (RAM), a nonvolatile memory and an interface unit, and controls each component of the action support server 50.

Specifically, as illustrated in FIG. 14, the main control unit 51 according to the present embodiment functions as a user information acquiring unit 511, a user information recording control unit 512, a preference determination unit 513, a support content deciding unit 514, and an execution unit 515.

The user information acquiring unit 511 acquires information on a user from each of the HMDs 1A and 1B via the communication unit 52. The HMDs 1A and 1B each transmit user information recorded on the user information recording unit 14 to the action support server 50 via the communication unit 9.

The user information recording control unit 512 performs control such that the user information (including attribute information such as sex, age and marital status, and information on the present location) acquired by the user information acquiring unit 511 is recorded on the user information recording unit 54.

The preference determination unit 513 determines preferences of the users 60A and 60B on the basis of the user information recorded on the user information recording unit 54. Specifically, the preference determination unit 103 determines a preference of a user such as a hobby and a taste, and a type of the other sex. In addition to a preference recognized by a user himself/herself (preferences in the public level and the private level), a preference in the subconscious mind, which a user himself/herself has not recognized, may also be determined on the basis of content written by the user into an SNS or a blog.

The relationship determination unit 516 determines whether a relationship between users is good or bad, on the basis of the user information recorded on the user information recording unit 54. Specifically, the relationship determination unit 516 parses content written by each user into an SNS, a blog, or electronic mail to determine a relationship between the users (such as good/bad (quarreling) relationships, private friendships, and business relationships).

The support content deciding unit 514 identifies a combination of users whose hobbies and tastes match with each other or a combination of an unmarried male user and an unmarried female user whose types of the other sex match with each other, on the basis of the preference of each user determined by the preference determination unit 513, and decide content for supporting action of the two (or more) users in the identified combination such that the two users come across each other.

The support content deciding unit 514 may then consider a state of each user on the basis of the biological information and the attribute information included in the user information and may reference the support pattern DB 55 to extract a search keyword used for searching for information on a place at which the two users come across. When the support content deciding unit 514 has decided, for example, content for offering such action support that users 60A and 60B whose types of the other sex match with each other and whose preferences are the same (“sake,” for example) come across each other, the support content deciding unit 514 extracts search keywords in the following way on the basis of the user information recorded on the user information recording unit 54 and the preferences determined by the preference determination unit 513.

First of all, the support content deciding unit 514 grasps that the user 60A is an unmarried man according to the user information on the user 60A, that the user 60A is now stressed about work according to the biological information detected in real time, and that the user 60A is currently located in an X district. Meanwhile, the support content deciding unit 514 grasps that the user 60B is an unmarried woman according to the user information on the user 60B, that the user 60B is now tired from work according to the biological information detected in real time, and that the user 60B is currently located in a Y district.

In this case, the support content deciding unit 514 uses situations of “sake,” “woman,” “tiredness,” “alone,” “X district,” and “Y district” and references the support pattern DB 55 to extract search keywords such as a “casual bar/pub a woman can enjoy alone” and “near from the X district and the Y district.” The support content deciding unit 514 then uses the extracted search keywords to collect information on a place at which the two users come across each other.

The support content deciding unit 514 can also decide support content for introducing given users to each other or preventing given users from coming across each other, in accordance with a relationship between the users, which has been determined by the relationship determination unit 516.

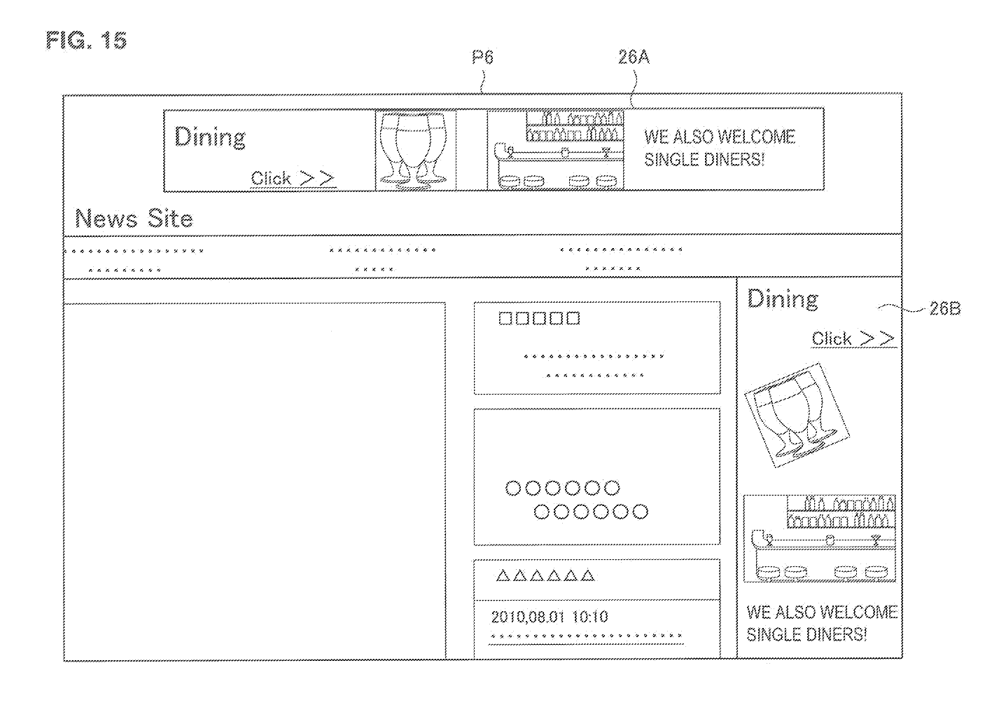

The execution unit 515 generates a control signal that causes the showing device 16 of each of the HMDs 1A and 1B to execute the support content decided by the support content deciding unit 514, and transmits the generated control signal to each of the HMDs 1A and 1B via the communication unit 52. The execution unit 515 then uses an indirect process that works on the subconscious mind of each user such that the two users are not aware that the action has been offered for the two users to come across each other and the two users select action for their natural meeting. An example of such indirect processes will be described with reference to FIG. 15.

FIG. 15 is a diagram for describing an example of the indirect action support according to the second embodiment. As illustrated in FIG. 15, advertisements for the same particular bar are displayed in banner advertising spaces 26A and 26B and advertising spaces of streaming broadcast of a Web screen P6 that the users 60A and 60B are browsing. The web screen P6 may be displayed on the display units 2 of the HMD 1, or may also be displayed on a display unit of the user's smartphone, mobile phone terminal, or PC terminal paired with the HMD 1. This allures the users 60A and 60B, who are each stressed and tired from work, to the advertised bar on the way home from work without making the users 60A and 60B aware that the action is offered for the two users to come across each other, allowing the male and female users whose preferences match with each other to come across each other at the bar that the users have unconsciously decided to enter.

(Communication Unit)

The communication unit 52 transmits data to and receives data from an external apparatus. The communication unit 52 according to the present embodiment communicates with the HMDs 1A and 1B directly or via the network 20.

(User Information Recording Unit)

The user information recording unit 54 records user information on a user acquired by the user information acquisition unit 511 under the control of the user information recording control unit 512.

(Support Pattern DB)

The support pattern DB 55 stores search keywords in association, the search keywords being used for collecting information that the support content deciding unit 514 uses to decide support content. Keywords such as a “casual bar/pub a woman can enjoy alone” and “near from . . . district” are stored in association with words such as “sake,” “woman,” “tiredness,” “alone,” and “ . . . district.”

### 3-3. Operational Processing

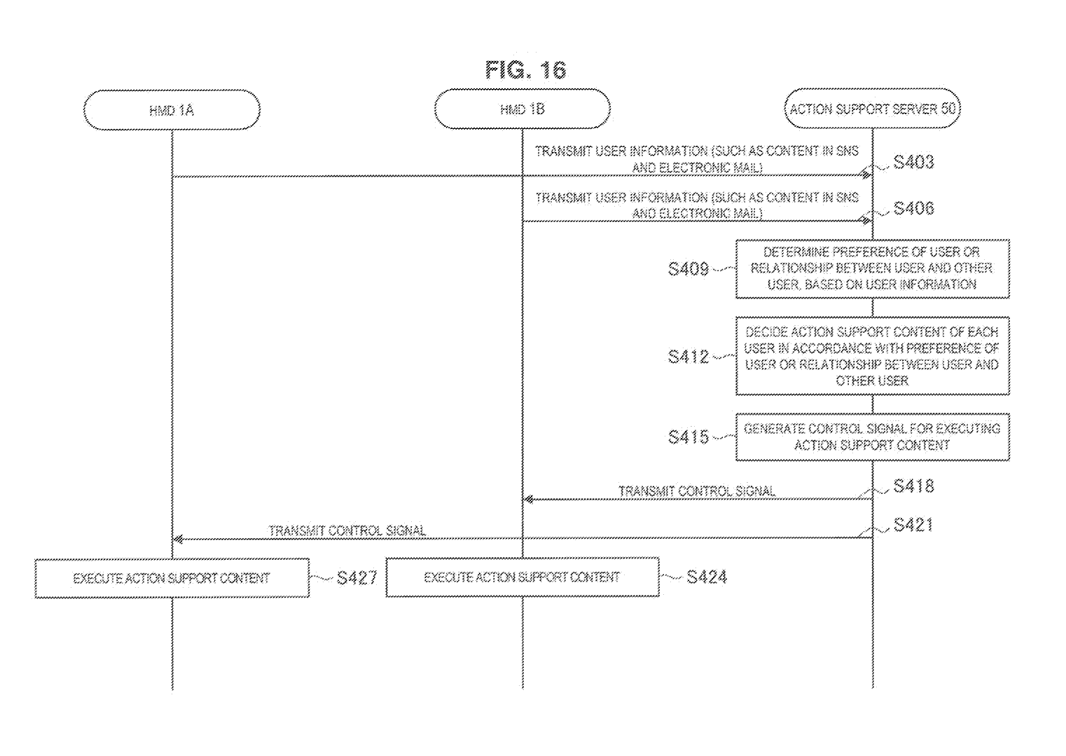

The configuration of the action support server 50 according to the second embodiment has been described so far. Next, action support processing according to the present embodiment will be specifically described with reference to FIG. 16.

FIG. 16 is a flowchart illustrating the action support processing according to the second embodiment. The operational processing as illustrated in FIG. 16 is regularly/irregularly performed.

As illustrated in FIG. 16, in steps S403 and S406, each of the HMDs 1A and 1B transmits user information (such as content written into an SNS, a blog and electronic mail, schedule information, information on a present location, and user attribute information) stored in each user information recording unit 14 to the action support server 50.

Next, in step S409, the action support server 50 determines a preference of each user by using the preference determination unit 513 or a relationship between the users by using the relationship determination unit 516 on the basis of the user information acquired from each of the HMDs 1A and 1B.

In step S412, the support content deciding unit 514 of the action support server 50 then decides action support content for each user in accordance with the preference of each user determined by the preference determination unit 513 or the relationship between the users determined by the relationship determination unit 516. Specifically, the support content deciding unit 514 decides, for example, content for supporting action of users whose types of the other sex match with each other such that the users come across each other. When a plurality of users in a good relationship are located within a predetermined distance, the support content deciding unit 514 decides content for supporting action of each user such that the users come across each other. To the contrary, when a plurality of users in a bad relationship are located within a predetermined distance, the support content deciding unit 514 decides content for supporting action of each user such that the users do not come across each other.

In step S415, the execution unit 515 of the action support server 50 generates a control signal for indirectly executing the action support content decided by the support content deciding unit 514 by using the showing device 16 of each of the HMDs 1A and 1B.

Next, in steps S418 and S421, the communication unit 52 of the action support server 50 transmits the control signal generated by the execution unit 515 to each of the HMDs 1A and 1B.

In steps S424 and S427, each of the HMD 1A and 1B then indirectly executes the action support content by using the showing device 16 in accordance with the control signal transmitted from the action support server 50.

As described above, the action support system according to the second embodiment supports action of users in accordance with the users' types of the other sex and a relationship between the users such that the users come across each other or do not come across each other, thereby allowing the users to lead a more comfortable life. Action support is indirectly offered in this way so as to work on the subconscious mind of a user, reducing annoyance and stress caused by direct advice and allowing a user to unconsciously lead a more comfortable life.

### 4. THIRD EMBODIMENT

A preference of a user is determined, action support content according to the preference of the user is decided, and then the action support content is executed in a process according to a preference level of the user in the second embodiment. Particularly, action support is indirectly offered so as to work on the subconscious mind of a user, thereby allowing for natural action support without making the user feel stressed. The action support apparatus according to an embodiment of the present disclosure is not limited to each embodiment discussed above. An action support apparatus can also be implemented that, for example, estimates a user's next action and then indirectly supports the action so as to allow the user to avoid a disadvantage in the action. Accordingly, a user does not have to take trouble to input a definite objective or receive annoying advice, yet can lead a safer and more comfortable life.

### 4-1. Configuration of HMD 100

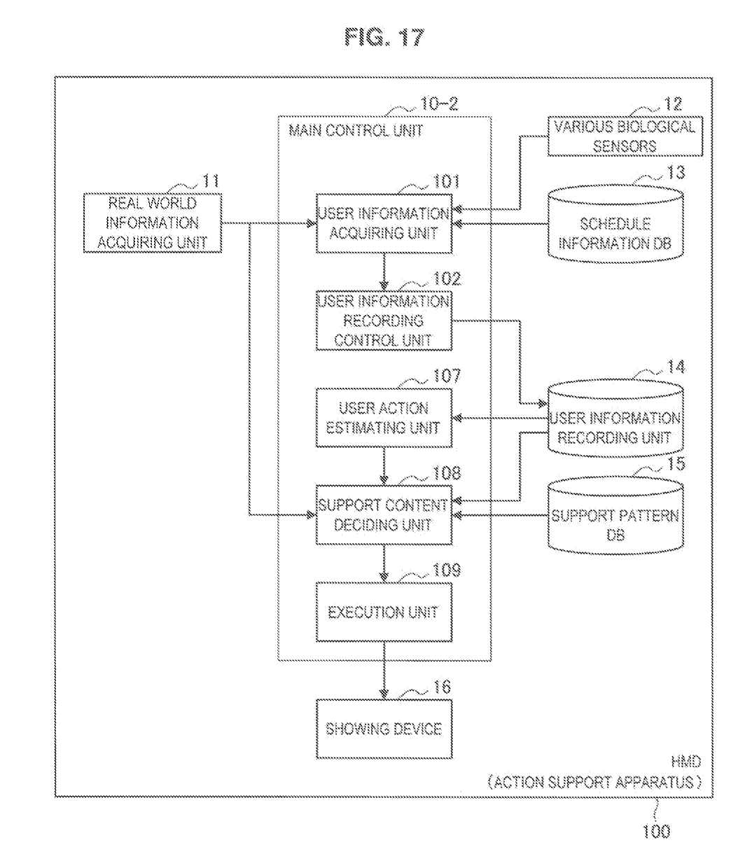

FIG. 17 is a block diagram illustrating a configuration of an HMD 100 (example of the action support apparatus) according to a third embodiment. As illustrated in FIG. 17, the HMD 100 includes a main control unit 10-2, a real world information acquiring unit 11, various biological sensors 12, a schedule information DB 13, a user information recording unit 14, a support pattern DB 15, and a showing device 16. The functions of the real world information acquiring unit 11, the various biological sensors 12, the schedule information DB 13, the user information recording unit 14, the support pattern DB 15, and the showing device 16 are the same functions described in the first embodiment, so that the description will be herein omitted.

As illustrated in FIG. 17, the main control unit 10-2 functions as a user information acquiring unit 101, a user information recording control unit 102, a user action estimating unit 107, a support content deciding unit 108, and an execution unit 109. The functions of the user information acquiring unit 101 and the user information recording control unit 102 are the same functions described in the first embodiment, so that the description will be herein omitted.

The user action estimating unit 107 estimates future action of a user on the basis of schedule information on the user recorded on the user information recording unit 14, or information obtained from an SNS, a blog, electronic mail, and a communication tool such as a chat tool. For example, if electronic mail transmitted on Jun. 14, 2013 shows “I will arrive at Yokohama around 10 o'clock tomorrow night,” and “I will directly go to your house,” the user action estimating unit 107 can estimate future action of the user that the user is going to the house of the addressee from Yokohama Station at 10 o'clock on the night of Jun. 15, 2013.

The support content deciding unit 108 decides content for supporting action (beneficial action) for allowing the user to avoid any disadvantageous situation predicted in the future action of the user estimated by the user action estimating unit 107. The support content deciding unit 108 can predict a disadvantageous situation to the user on the basis of a present state of the user recorded on the user information recording unit 14, attribute information on the user, and information on the real world (information on a dangerous region) acquired by the real world information acquiring unit 11.

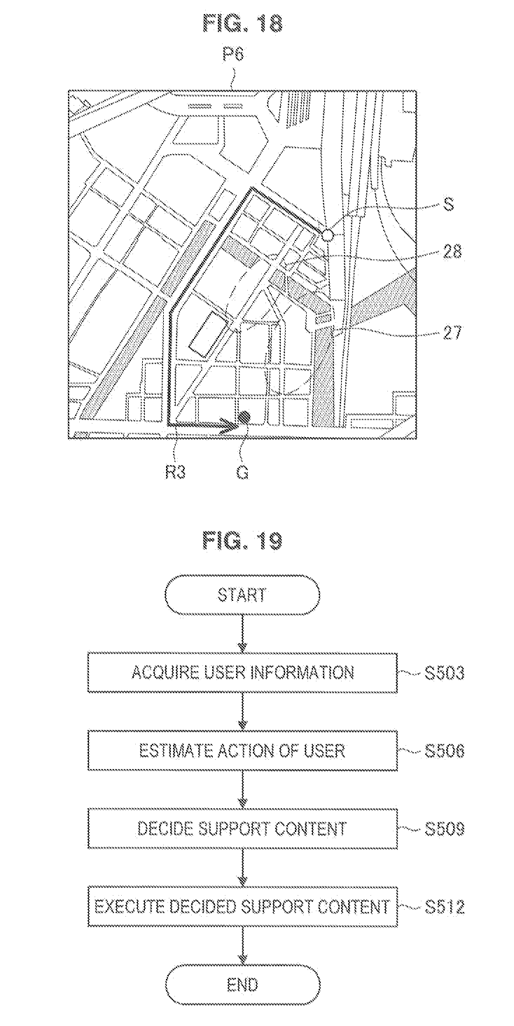

The support content deciding unit 108 identifies, for example, a search keyword “young woman” from the attribute information on the user, search keywords “10 o'clock at night” and “Yokohama Station” from the estimated content of action, a search keyword “rain” from the information on the real world, and a search keyword “on foot” from the present state of the user, and references the support pattern DB 15 to extract related keywords. The support content deciding unit 108 uses the identified search keywords and the extracted related keywords to access a news site, a bulletin board, and an SNS in a network by using keywords “Yokohama Station, security, safe street,” “Yokohama Station, light street,” and “Yokohama Station, rain, puddle” in order to collect information. The support content deciding unit 108 can hereby identify a position of a street of rich/poor security, a position of a light/dark street, and a place often having a puddle. The support content deciding unit 108 decides content for supporting a route that avoids a street of poor security, a dark street, or a place often having a puddle, offering support that allows a user to avoid any disadvantageous situation predicted in future action of the user. Here, an example of the decisions of support content by the support content deciding unit 108 will be described with reference to FIG. 18.

FIG. 18 is a diagram for describing route support according to the third embodiment. As illustrated in FIG. 18, if a user is estimated to go from the present location S (Yokohama Station, for example) to the destination G (friend's house, for example), the support content deciding unit 108 collects information on an area around the present location S from a network to identify a dark street 27 of poor security and a place 28 often having a puddle. The support content deciding unit 108 then decides support content for guiding the user to a route R3 that avoids the dark street 27 of poor security and the place 28 often having a puddle.

When a plurality of search results are found, the support content deciding unit 108 may take a vote in order to enhance the credibility of the information collected from the network or may weight the search results such that new information is more credible than old information.

The execution unit 109 controls the showing device 16 to execute the support content decided by the support content deciding unit 108. Here, the execution unit 109 indirectly executes the support content so as to work on the subconscious mind of the user, thereby reducing annoyance and stress caused by direct advice and allowing the user to unconsciously lead a more comfortable and safer life.

### 4-2. Operational Processing

Next, operational processing according to the present embodiment will be described with reference to FIG. 19. FIG. 19 is a flowchart illustrating operational processing of the action support apparatus according to the third embodiment. As illustrated in FIG. 19, in step S503, the user information acquiring unit 101 first acquires user information, and records the acquired user information on the user information recording unit 14 by using the user information recording control unit 102. The user information here includes content written into an SNS, a blog or electronic mail, attribute information on a user, and information on a present location.

Next, in step S506, the user action estimating unit 107 estimates future action of the user on the basis of the user information recorded on the user information recording unit 14. For example, if the user is currently located in Yokohama Station, if it is now 10 o'clock at night, and if content written by the user in electronic mail on the previous day shows “I will arrive at Yokohama at 10 o'clock tomorrow night. I will directly go to your house,” the user is estimated to go to the house of the addressee. The location of the addressee's house (friend's house) may be identified on the basis of address information registered in address book data.

In step S509, the support content deciding unit 108 then decides content for supporting action (beneficial action) for allowing the user to avoid a disadvantageous situation predicted in the estimated future action of the user. For example, the support content deciding unit 108 decides support content for guiding the user to a route that avoids dark streets of poor security from the present location, Yokohama Station, to the friend's house.

In step S512, the execution unit 109 then executes the decided support content. The execution unit 109 indirectly executes the support content so as to work on the subconscious mind of the user, thereby reducing annoyance and stress caused by direct advice and allowing the user to unconsciously lead a comfortable and safe life.

The operational processing according to the present embodiment has been specifically described so far. Additionally, the support content deciding unit 108 can also decide support content for guiding a user to a route, on the basis of environmental information, in which the user can be more comfortable in spite of rich/poor security. Specifically, for example, the support content deciding unit 108 can identify heat/cold or a discomfort index on the basis of temperature/humidity, and an area of a strong building wind and an area of a comfortable breeze on the basis of force of wind/wind directions, and decide support content for guiding the user to a route in which the user can be more comfortable.

### 4-3. Applied Example

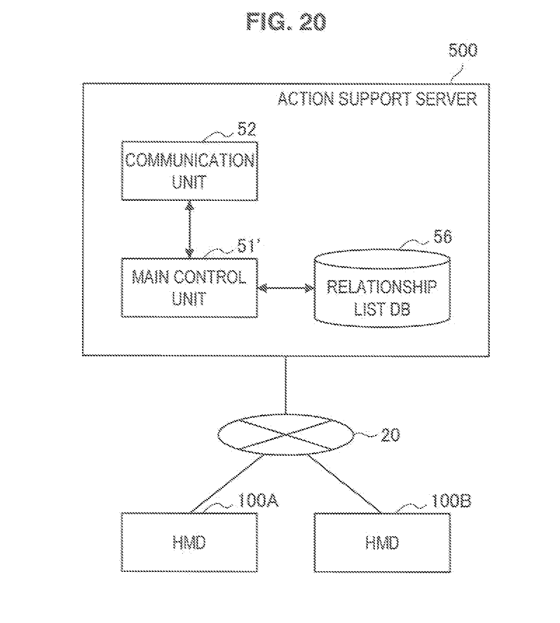

Action of individuals is primarily supported in the third embodiment, but the action support apparatus according to an embodiment of the present disclosure is not limited to support for an individual. An action support system can also be implemented that offers support to users such that the users avoid any disadvantage in estimated future action, on the basis of their relationships. Specifically, as illustrated in FIG. 20, such support may be implemented by an action support system including an HMD 100A to be worn by a user 60A, an HMD 100B to be worn by a user 60B, and an action support server 500.

As illustrated in FIG. 20, the action support server 500 includes a communication unit 52, a main control unit 51′, and a relationship list DB 56. The main control unit 51′ updates data stored in the relationship list DB 56 on the basis of relationship lists reported by the HMDs 100A and 100B. The main control unit 51′ also reports scheduled action of a user, which has been reported by one of the HMDs 100, to the other HMD 100.

(Operational Processing)

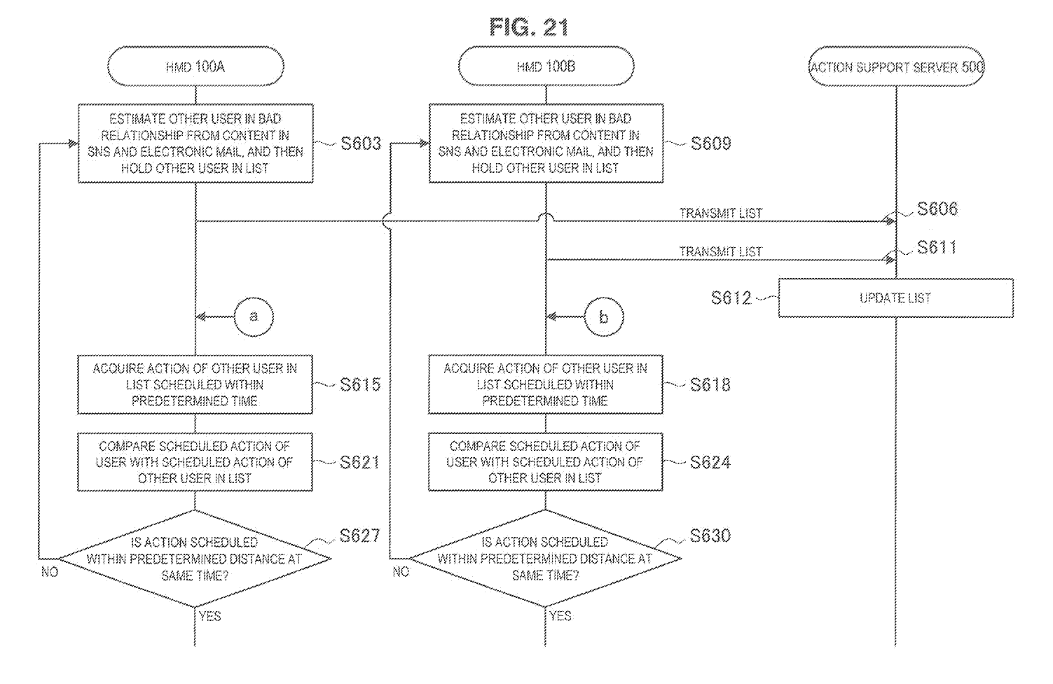

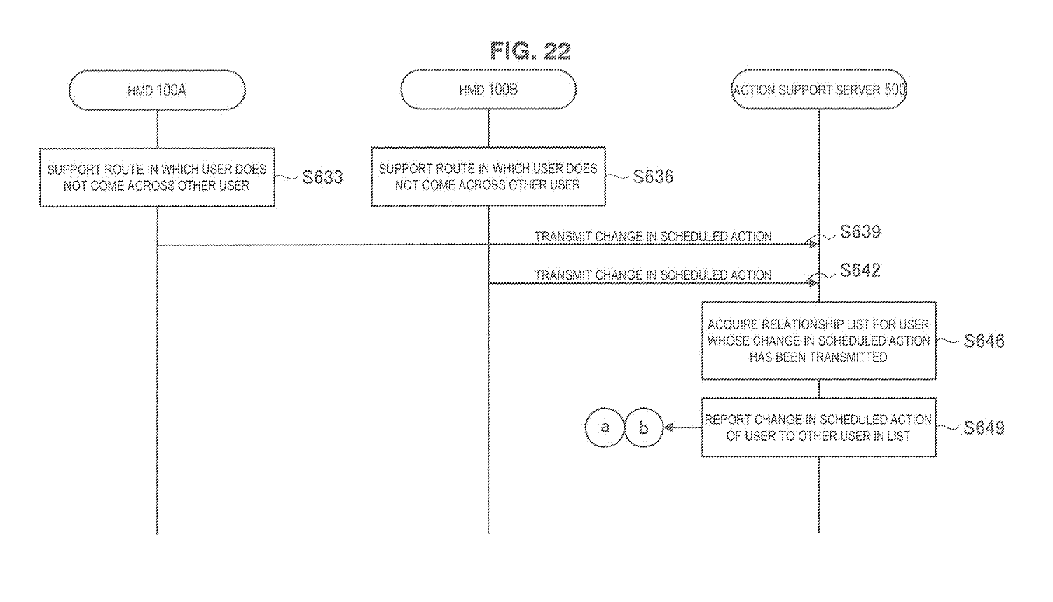

Next, operational processing according to the present embodiment will be described with reference to FIGS. 21 and 22. FIGS. 21 and 22 each are a flowchart illustrating operational processing of an action support system according to an applied example of the third embodiment. As an example, such support is offered that users in a bad relationship do not come across each other in estimated future action of the users. The main control unit 10-2 of each of the HMDs 100A and 100B may determine the relationship between the users as the same function as the relationship determination unit 516 according to the second embodiment.

As illustrated in FIG. 21, in steps S603 and S609, each of the HMDs 100A and 100B first estimates the other user in a bad relationship on the basis of content written into SNSs, blogs, and electronic mail, and holds the user in a list.

In steps S606 and S611, each of the HMDs 100A and 100B then transmits the list to the action support server 500. Each of the HMDs 100A and 100B regularly/irregularly performs the processing (S603 to S611).

Next, in step S612, the action support server 500 updates the relationship list DB 56 in accordance with the list transmitted from each of the HMDs 100A and 100B. This keeps the list updated at all times, the list showing the relationship between the users and being stored in the relationship list DB 56.

In steps S615 and S168, each of the HMDs 100A and 100B then acquires scheduled action of the other user in a bad relationship within a predetermined time, who appears in the list. The scheduled action of the other user may be acquired from the HMD worn by the other user or from the action support server 500. Specifically, for example, the HMD 100A acquires the scheduled action of the user 60B from the action support server 500, the user 60B being in a bad relationship with the user 60A wearing the HMD 100A.

In steps S621 and S624, each of the HMDs 100A and 100B compares the scheduled action of the user with the scheduled action of the other user appearing in the other list. Specifically, the HMD 100A, for example, estimates the scheduled action of the user 60A by using the user action estimating unit 107, and compares, by using the support content deciding unit 108, the estimated scheduled action of the user 60A with the scheduled action of the user 60B acquired in S615.

Next, in steps S627 and S630, each of the HMDs 100A and 100B determines whether any action is scheduled within a predetermined distance at the same time. Specifically, the HMD 100A, for example, determines, by using the support content deciding unit 108, whether the user 60A and the user 60B each have any action scheduled within a predetermined distance at the same time.

If it is determined that any action is scheduled within a predetermined distance at the same time (S627/Yes and S630/Yes), each of the HMDs 100A and 100B then supports a route in which the user does not come across the other user, in steps S633 and S636 as illustrated in FIG. 22. Specifically, for example, when any action is scheduled within a predetermined distance at the same time, the user A is very likely to come across the user B. Accordingly, the support content deciding unit 108 of the HMD 100A decides content for supporting such action that the user A does not come across the user B in a bad relationship. The execution unit 109 then executes the decided action support content. The execution unit 109 indirectly executes the support content so as to work on the subconscious mind of the user, thereby reducing annoyance and stress caused by direct advice and allowing the user to unconsciously avoid the other user in a bad relationship.

Next, in steps S639 and S642, each of the HMDs 100A and 100B transmits a change in the scheduled action of the user to the action support server 500.

In step S646, the main control unit 51′ of the action support server 500 acquires, from the relationship list DB 56, a relationship list for the user whose change in the scheduled action has been transmitted. Specifically, for example, when HMD 100A transmits a change in the scheduled action of the user A, the main control unit 51′ acquires, from the relationship list DB 56, a relationship list indicating a relationship between the user 60A and the other user.

In step S649, the main control unit 51′ of the action support server 500 reports the change in the scheduled action of the user to the other user appearing in the acquired list. The report of the change in the scheduled action allows each of the HMDs 100A and 100B to acquire new scheduled action of the other user in S615 and S618. For example, the main control unit 51′ of the action support server 500 reports the change in the scheduled action of the user 60A to the user 60B appearing in the relationship list, which indicates a relationship between the user 60A and the other user, thereby allowing the HMD 100B worn by the user 60B to acquire new scheduled action of the other user 60A.

The action support system according to the applied example of the third embodiment has been specifically described so far. The action support system allows scheduled action of each user in the future to be estimated, so that action of the user can be supported such that the user comes across another user or does not come across another user in accordance with whether a relationship is good or bad. Additionally, the processing in steps S603 and S609 as illustrated in FIG. 21 (listing another user in a bad relationship with a user) may be performed regularly by the action support server 500 out of synchronization with the HMDs 100A and 100B.

### 5. CONCLUSION

As discussed above, the action support apparatus according to an embodiment of the present disclosure can execute support content matching with a preference of a user in a process according to a preference level of the user.

Specifically, according to the first embodiment, for example, if a preference level of a user is the private level indicating that the user does not want others to know a preference, or the latent level indicating that the user himself/herself has not recognized the preference, action support is indirectly offered so as to work on the subconscious mind of the user, reducing stress and burdens of the action support on the user.

According to the second embodiment, action support is offered that finds a combination of users whose types of the other sex match with each other and indirectly guides the users such that the users naturally come around each other. According to the second embodiment, such action support is also offered that indirectly guides users such that the users naturally come around each other or do not come across each other by accident in accordance with whether the users are in a good relationship or a bad relationship.

Furthermore, according to the third embodiment, support is offered that estimates future action of a user and allows the user to avoid a disadvantage in the estimated action. Action support is then indirectly offered so as to work on the subconscious mind of the user, reducing stress of advice and allowing the user to unconsciously lead a more comfortable life.

According to the applied example of the third embodiment, support is offered that allows users to avoid a disadvantage in estimated future action of each user in accordance with whether the users are in a good relationship or a bad relationship.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

It is also possible to make a computer program for causing hardware such as CPU, ROM, and RAM built in the HMD 1, HMD 100, the action support server 50, or the action support server 500 to execute the function of the HMD 1, HMD 100, the action support server 50, or the action support server 500. There is also provided a computer-readable storage medium having the computer program stored therein.

The steps in the operational processing in each embodiment of the present disclosure do not necessarily have to be executed in the chronological order as described in the flowcharts. For example, the steps may be executed in a different order from the flowcharts, or in parallel. Specifically, steps S118 to S124 as illustrated in FIG. 4, for example, may be executed in parallel.

It is described in the first embodiment that the execution unit 105 directly executes support content when a preference level of a user is the public level L1, the limited public level L1′, or the private level L2. The present embodiment, however, is not limited thereto. The execution unit 105 may exceptionally execute support content indirectly in a particular case, for example. Specifically, when support content such as weight loss, which forces a user to suppress his/her desire, is predicted to impose stress on the user, the execution unit 105 indirectly executes the support content.

The effects described herein are merely explanatory and illustrative, and not limited. The technology according to the embodiment of the present disclosure may attain other effects obvious to those skilled in the art from the present specification in addition to the above-described effects or instead thereof.

Additionally, the present technology may also be configured as below.

(1) An action support apparatus including:

an acquisition unit configured to acquire information on a user;

a support content deciding unit configured to decide support content for supporting a preference of the user determined on the basis of the information on the user acquired by the acquisition unit; and

an execution unit configured to execute the support content in a process according to a level of the preference.

(2) The action support apparatus according to (1),

wherein the level of the preference is a level according to whether the user has recognized the preference, and whether the user allows another person to know the preference.

(3) The action support apparatus according to (1) or (2),

wherein the execution unit executes the support content by using a display unit or an audio output unit.

(4) The action support apparatus according to any one of (1) to (3),

wherein, when the level of the preference is a latent level indicating that the user has not recognized the preference, the execution unit indirectly executes the support content to work on a subconscious mind of the user.

(5) The action support apparatus according to (4).

wherein the execution unit indirectly executes the support content by using affordance, illusion, or psychological guidance.

(6) The action support apparatus according to (4),

wherein the execution unit indirectly executes the support content by using at least one of image processing on an image signal and audio processing on an audio signal, the image processing including brightness change, color saturation change, aspect ratio change, rotation, enlargement/reduction, transformation, composition, mosaic/blurring, and color change, the audio processing including echo/delay, distortion/flanging, surround sound creation/channel change.

(7) The action support apparatus according to (4),

wherein the support content deciding unit decides support content for displaying information regarding an item or a service matching with the preference of the user, and

wherein the execution unit indirectly executes the support content by displaying the information regarding the item or the service on an advertising column in a displayed screen.

(8) The action support apparatus according to (4),

wherein the support content deciding unit decides support content for guiding the user to a place in which an item or a service matching with the preference of the user is provided, and

wherein the execution unit indirectly executes the support content by changing a part of a map image or a captured image of an area in a direction in which the user is looking, and then displaying the changed map image or the changed captured image in a manner that the guided route is recognized as a most suitable route.

(9) The action support apparatus according to (8),

wherein the execution unit indirectly executes the support content by processing the captured image in a manner that a street other than the guided route looks dark or looks like an uphill slope, and then displaying the processed captured image on a display unit of an HMD worn by the user.

(10) The action support apparatus according to (8).

wherein the execution unit indirectly executes the support content by processing the map image in a manner that the guided route is shorter than another route.

(11) The action support apparatus according to any one of (1) to (10),

wherein, when the level of the preference is a private level indicating that the user has recognized the preference and the user does not allow the public to know the preference, and when there is no one around the user, the execution unit directly executes the support content.

(12) The action support apparatus according to any one of (1) to (11),

wherein, when the level of the preference is a limited public level indicating that the user has recognized the preference and the user allows a particular range of people to know the preference, and when a person around the user is included in the particular range, the execution unit directly executes the support content.

(13) The action support apparatus according to any one of (1) to (12),

wherein, when the level of the preference is a public level indicating that the user has recognized the preference and the user allows the public to know the preference, the execution unit directly executes the support content in spite of whether there is anyone around the user.

(14) The action support apparatus according to any one of (1) to (13),

wherein the information on the user acquired by the acquisition unit includes at least one of biological information on the user, schedule information on the user, attribute information on the user, and content input by the user into one of electronic mail, an electronic bulletin board, a blog, and an SNS.

(15) The action support apparatus according to any one of (1) to (14),

wherein the acquisition unit acquires information on users,

wherein the support content deciding unit decides support content for guiding particular users among the users to an identical place, the particular users having preferences matching with each other, and

wherein the execution unit indirectly executes the support content to work on subconscious minds of the particular users.

(16) The action support apparatus according to any one of (1) to (15),

wherein the acquisition unit acquires information on users,

wherein the support content deciding unit decides support content according to whether the users are in a good relationship or a bad relationship, and

wherein the execution unit indirectly executes the support content to work on subconscious minds of the users.

(17) The action support apparatus according to any one of (1) to (16).

wherein the support content deciding unit decides content for supporting the user in avoiding a disadvantage in estimated future action of the user.

(18) An action support method including:

acquiring information on a user;

determining a preference of the user on the basis of the acquired information on the user;

deciding support content for supporting the preference of the user; and

executing the support content by a processor in a process according to a type of the preference.

(19) A program for causing a computer to function as:

an acquisition unit configured to acquire information on a user;

a support content deciding unit configured to determine a preference of the user on the basis of the information on the user acquired by the acquisition unit, and to decide support content for supporting the preference of the user; and

an execution unit configured to execute the support content in a process according to a type of the preference.

(20) A non-transitory computer-readable storage medium having a program stored therein, the program causing a computer to function as:

an acquisition unit configured to acquire information on a user;

a support content deciding unit configured to determine a preference of the user on the basis of the information on the user acquired by the acquisition unit, and to decide support content for supporting the preference of the user; and

an execution unit configured to execute the support content in a process according to a type of the preference.

What is claimed is:

1. An action support apparatus comprising:
an acquisition unit configured to acquire information on a user;
a support content deciding unit configured to decide support content for supporting a preference of the user determined on the basis of the information on the user acquired by the acquisition unit; and
an execution unit configured to execute the support content in a process according to a level of the preference.

2. The action support apparatus according to claim 1,
wherein the level of the preference is a level according to whether the user has recognized the preference, and whether the user allows another person to know the preference.

3. The action support apparatus according to claim 1,
wherein the execution unit executes the support content by using a display unit or an audio output unit.

4. The action support apparatus according to claim 1,
wherein, when the level of the preference is a latent level indicating that the user has not recognized the preference, the execution unit indirectly executes the support content to work on a subconscious mind of the user.

5. The action support apparatus according to claim 4,
wherein the execution unit indirectly executes the support content by using affordance, illusion, or psychological guidance.

6. The action support apparatus according to claim 4,
wherein the execution unit indirectly executes the support content by using at least one of image processing on an image signal and audio processing on an audio signal, the image processing including brightness change, color saturation change, aspect ratio change, rotation, enlargement/reduction, transformation, composition, mosaic/blurring, and color change, the audio processing including echo/delay, distortion/flanging, surround sound creation/channel change.

7. The action support apparatus according to claim 4,
wherein the support content deciding unit decides support content for displaying information regarding an item or a service matching with the preference of the user, and
wherein the execution unit indirectly executes the support content by displaying the information regarding the item or the service on an advertising column in a displayed screen.

8. The action support apparatus according to claim 4,
wherein the support content deciding unit decides support content for guiding the user to a place in which an item or a service matching with the preference of the user is provided, and
wherein the execution unit indirectly executes the support content by changing a part of a map image or a captured image of an area in a direction in which the user is looking, and then displaying the changed map image or the changed captured image in a manner that the guided route is recognized as a most suitable route.

9. The action support apparatus according to claim 8,
wherein the execution unit indirectly executes the support content by processing the captured image in a manner that a street other than the guided route looks dark or looks like an uphill slope, and then displaying the processed captured image on a display unit of an HMD worn by the user.

10. The action support apparatus according to claim 8,
wherein the execution unit indirectly executes the support content by processing the map image in a manner that the guided route is shorter than another route.

11. The action support apparatus according to claim 1,
wherein, when the level of the preference is a private level indicating that the user has recognized the preference and the user does not allow the public to know the preference, and when there is no one around the user, the execution unit directly executes the support content.

12. The action support apparatus according to claim 1,
wherein, when the level of the preference is a limited public level indicating that the user has recognized the preference and the user allows a particular range of people to know the preference, and when a person around the user is included in the particular range, the execution unit directly executes the support content.

13. The action support apparatus according to claim 1,
wherein, when the level of the preference is a public level indicating that the user has recognized the preference and the user allows the public to know the preference, the execution unit directly executes the support content in spite of whether there is anyone around the user.

14. The action support apparatus according to claim 1,
wherein the information on the user acquired by the acquisition unit includes at least one of biological information on the user, schedule information on the user, attribute information on the user, and content input by the user into one of electronic mail, an electronic bulletin board, a blog, and an SNS.

15. The action support apparatus according to claim 1,
wherein the acquisition unit acquires information on users,
wherein the support content deciding unit decides support content for guiding particular users among the users to an identical place, the particular users having preferences matching with each other, and
wherein the execution unit indirectly executes the support content to work on subconscious minds of the particular users.

16. The action support apparatus according to claim 1,
wherein the acquisition unit acquires information on users,
wherein the support content deciding unit decides support content according to whether the users are in a good relationship or a bad relationship, and
wherein the execution unit indirectly executes the support content to work on subconscious minds of the users.

17. The action support apparatus according to claim 1,
wherein the support content deciding unit decides content for supporting the user in avoiding a disadvantage in estimated future action of the user.

18. An action support method comprising:
acquiring information on a user;
determining a preference of the user on the basis of the acquired information on the user;
deciding support content for supporting the preference of the user; and
executing the support content by a processor in a process according to a type of the preference.

19. A program for causing a computer to function as:
an acquisition unit configured to acquire information on a user;
a support content deciding unit configured to determine a preference of the user on the basis of the information on the user acquired by the acquisition unit, and to decide support content for supporting the preference of the user; and
an execution unit configured to execute the support content in a process according to a type of the preference.

20. A non-transitory computer-readable storage medium having a program stored therein, the program causing a computer to function as:
an acquisition unit configured to acquire information on a user;
a support content deciding unit configured to determine a preference of the user on the basis of the information on the user acquired by the acquisition unit, and to decide support content for supporting the preference of the user; and
an execution unit configured to execute the support content in a process according to a type of the preference.
